(19) United States
(12) Patent Application Publication
(10) Pub. No.: US 2012/0022189 A1
(43) Pub. Date: Jan. 26, 2012

(54) CLEAR INK COMPOSITION

(75) Inventor: Shuichi Koganehira, Matsumoto-Shi (JP)

(73) Assignee: SEIKO EPSON CORPORATION, TOKYO (JP)

(21) Appl. No.: 13/179,628

(22) Filed: Jul. 11, 2011

(30) Foreign Application Priority Data
Jul. 23, 2010 (JP) 2010-166320

(51) Int. Cl. C09D 11/14

(52) U.S. Cl. 524/56

(57) ABSTRACT

An image is formed using a clear ink composition that includes an amino group-containing resin, water, a poor water-soluble alkanediol, a crystalline carbohydrate that is solid at 20° C., and a poly(oxyalkylene glycol) and does not include colorant (essentially free of colorant).

Priority is claimed under 35 U.S.C §119 to Japanese Application No. 2010-166320 filed on Jul. 23, 2010, which is hereby incorporated by reference in its entirety.

### BACKGROUND

1. Technical Field

The present invention relates to a clear ink composition that can form a high-quality image.

2. Related Art

An ink jet recording method is a printing process for conducting printing by letting ink droplets fly and adhere to a recording medium such as paper. According to recent innovative progress in ink jet recording technology, the ink jet recording method has become to be also used in the field of highly fine printing that has been achieved by silver halide photography or offset printing before. With the development of the ink jet recording method, inks for ink jet recording have been developed so that an image having gloss similar to that of silver halide photography can be formed by the ink jet recording on a recording medium, so-called exclusive paper, having high gloss comparable to that of photographic paper or art paper used in the fields of silver halide photography and offset printing. Furthermore, inks for ink jet recording that can realize image quality comparable to that of silver halide photography even when plain paper is used have been developed.

Incidentally, desk top publishing (DTP) has been spreading in recent years, in particular, in the printing field, with wide spreading of a technology for forming an image from digital data. Even when printing is performed by DTP, a color proof is produced in advance for comparing the gloss and color impression with those of an actual printed matter. The ink jet recording system is applied to output of the proof, and exclusive paper for ink jet recording is usually used as the recording medium because of requirements for high color reproducibility and high color stability of the printed matter in DTP.

A proof sheet, which is exclusive paper for ink jet recording, is produced so as to provide gloss and color impression similar to those of actual output printed on printing paper. Thus, the material for the exclusive paper is appropriately adjusted according to the type of printing paper, but production of exclusive paper that can cope with all of various types of printing paper causes an increase in manufacturing cost. Accordingly, in the use for color proof, there is a demand for conducting ink jet recording on printing paper rather than on exclusive paper, from a technical viewpoint. Furthermore, if it is possible to use a recorded matter produced directly on printing paper, not on exclusive paper, by ink jet recording as a final proof sample, the cost for proof can be significantly decreased, and, therefore, such use is demanded from an economical viewpoint. In addition, synthetic paper, which is widely used in the printing field and is produced by mixing inorganic filler and the like with a polyethylene resin or a polyester resin and then forming the mixture into a film, has recently attracted attention as a material that is excellent in recyclability and environment-friendly. There is a demand for conducting recording on such synthetic paper from the environmental viewpoint.

The printing paper is coated paper having a surface provided with a coating layer for receiving oil-based ink and thereby has a characteristic of being poor in aqueous-ink-absorbing ability due to the coating layer. Therefore, if an aqueous pigment ink, which is usually used in ink jet recording, is used, bleeding or aggregation spots may occur in an image because of low permeability of the ink into the recording medium (printing paper).

For the above-mentioned problems, for example, JP-A-2005-194500 discloses a pigment ink that is improved in bleeding and is excellent in gloss on exclusive paper by using a polysiloxane compound as a surfactant and including an alkanediol, such as 1,2-hexanediol, as a solubilization aid. In addition, JP-A-2003-213179, JP-A-2003-253167, and JP-A-2006-249429 propose methods to obtain high-quality images by controlling permeability of ink into recording media by adding a diol solvent, such as glycerin or 1,3-butanediol, or a triol solvent, such as pentanetriol, to the ink.

JP-A-2009-286998 and JP-A-2009-269964 propose ink compositions that can form a high-quality image and can inhibit occurrence of curling.

JP-A-2005-88238 proposes a liquid composition that contains a modified polyallylamine, but does not contain colorant and is used so as to adhere to a recording medium together with an ink composition. However, this liquid composition is for enabling a satisfactory cleaning operation while maintaining satisfactory color development and gloss and is completely different from the ink composition of the invention in the constitution and effect thereof.

JP-A-2007-261206 provides an ink set that can ensure high fixation and optical concentration at high-speed printing and can prevent bleeding. It is described that this ink set contains a polyallylamine, but the ink set is completely different from the ink composition of the invention.

JP-A-2010-691 provides an ink jet recording process that uses a line head and is excellent in color bleeding resistance. It is described that the fixing liquid used in this recording process contains a polyallylamine, but the fixing liquid is completely different from the ink composition of the invention.

### SUMMARY

The inventors have recently found the fact that when a clear ink composition containing water, a poor water-soluble alkanediol, a crystalline carbohydrate that is solid at 20° C. (hereinafter may be simply referred to as “crystalline carbohydrate”), a poly(oxyalkylene glycol), and an amino group-containing resin, but not containing colorant is used as an ink composition, a high-quality image being free from bleeding and beading and, in particular, being excellent in graininess and inhibition of curling can be achieved, for example, even when printing with a short difference in ink landing time is performed on a recording medium having a low water-absorbing property, such as printing paper.

Accordingly, an advantage of some aspects of the invention is to provide a clear ink composition that can form a high-quality image being free from bleeding and beading and, in particular, being excellent in graininess and inhibition of curling, for example, even when printing with a short difference in ink landing time is performed on a recording medium having a low water-absorbing property, such as printing paper.

The clear ink composition according to the invention contains an amino group-containing resin, water, a poor water-soluble alkanediol, a crystalline carbohydrate that is solid at 20° C., and a poly(oxyalkylene glycol), but does not contain colorant (essentially free of colorant).

In the case of using the clear ink composition of the invention, it is possible to realize a high-quality image being free from bleeding and beading and, in particular, being excellent in graininess and inhibition of curling with an ink composition, for example, even when printing with a short difference in ink landing time is performed on a recording medium having a low aqueous-ink-absorbing property, such as printing paper.

### BRIEF DESCRIPTION OF THE DRAWINGS

The invention will be described with reference to the accompanying drawings, wherein like numbers reference like elements.

FIG. 1 shows ink dots recorded using the clear ink composition of Example 5 shown below and Lc of Reference Example 1, wherein it is confirmed that the dot diameter is smaller than that shown in FIG. 2.

FIG. 2 shows ink dots recorded using the clear ink composition of Comparative Example 6 shown below and Lc of Reference Example 1.

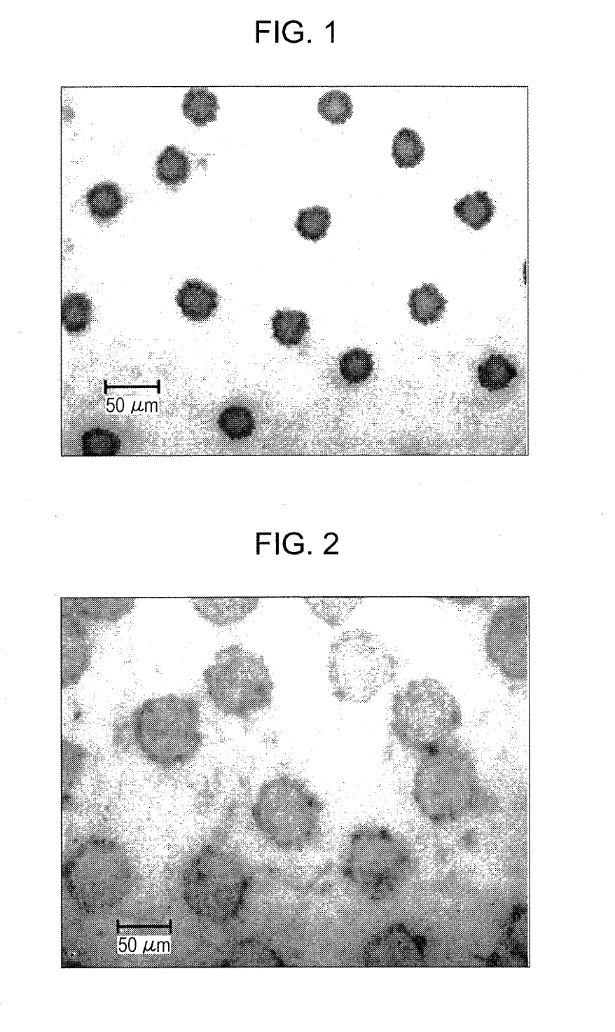

### DESCRIPTION OF EXEMPLARY EMBODIMENTS

In the specification, the hydrocarbon group portion of an alkanediol may be either a linear chain or a branched chain.

The term “water-soluble” means that the solubility in water (the amount of a solute in 100 g of water) at 20° C. is 10.0 g or more, and the term “poor water-soluble” means that the solubility in water (the amount of a solute in 100 g of water) is less than 1.0 g. The term “miscible” means that a uniform dispersion or solution can be obtained without aggregation or phase separation when the solubility in water (the amount of a solute in 100 g of water) at 20° C. is 10.0 g.

### Ink Composition

The clear ink composition according to an aspect of the invention contains an amino group-containing resin, water, a poor water-soluble alkanediol, a specific crystalline carbohydrate, and a poly(oxyalkylene glycol), but does not contain colorant (essentially free of colorant). By containing these organic solvents and other components in combination, for example, an ink composition on printing paper is inhibited from bleeding and beading. Thus, it is possible to provide a clear ink composition that can form a high-quality image being free from bleeding and beading and, in particular, being excellent in graininess and inhibition of curling, in particular, even when printing with a short difference in ink landing time is performed. The clear ink composition according to the invention can provide superior image quality with high definition and a small dot size of a landed ink droplet in printing by containing these organic solvents and other components in combination.

The clear ink composition according to the invention is an ink composition not containing colorant and is preferably a clear ink composition having an impregnation function. The recorded dot recorded by a clear ink composition having the impregnation function has an effect of letting the clear ink composition itself impregnated with moisture. The reason thereof is not clear, but the crystalline carbohydrate may provide the impregnation function to the clear ink composition of the invention.

In the specification, the term “beading” means local density spots with similar colors occurring in monochromatic printing (for example, when a 6-inch square monochromatic image (which means that a single color is obtained as a result of the printing, and a plurality of ink compositions may be used for forming the color) is printed) and does not mean that a region not covered with the ink remains on a recording medium surface.

In an aspect of the invention, when thin printing paper having a paper weight of 73.3 to 104.7 g/m² or 104.7 to 209.2 g/m² is used, preferably, even when thin printing paper having a paper weight of 73.3 to 104.7 g/m² is used as the above-described recording medium, the printed face is inhibited from rolling inward, that is, so-called curling is inhibited from occurring.

It is not clear why a high-quality image being free from bleeding and beading can be formed by the ink composition containing a poor water-soluble alkanediol, in addition to a poly(oxyalkylene glycol) and a crystalline carbohydrate that is solid at 20° C., as described above, but it is assumed as follows.

The beading of an ink occurring in recording on printing paper is thought to be caused by that the printing paper repels the ink because of the high surface tensions of ink droplets and large contact angles of the ink droplets with the printing paper surface. The repelled ink droplets flow together with adjacent ink droplets to aggregate with one another, resulting in beading. Accordingly, it is believed that, in order to inhibit beading of ink, it is preferable to inhibit flowage spots of ink droplets by reducing the surface tension of the ink droplets.

The bleeding of ink occurring in recording on printing paper is thought to be caused by that since ink droplets have different surface tensions, ink droplets having low surface tensions adhered to the surface of the printing paper saturate ink droplets having high surface tensions and spread thereto, resulting in a flow of the ink. This ink flow is thought to be also affected by the difference of adhesion times of adjacent ink droplets and the sizes of droplets at the time of adhering.

Accordingly, it is believed that, in order to inhibit bleeding of ink, it is preferable to adjust the surface tensions of ink compositions to be equal. However, it is difficult that the intervals of adhesion times of adjacent ink droplets or the sizes of droplets at the time of adhering are also adjusted to be equal, and it is therefore believed that it is preferable to reduce flowage spots of ink droplets.

It is believed that, in the ink composition according to an aspect of the invention, ink having a low surface tension and low fluidity can be achieved without impairing other qualities required in an ink composition and that, as a result, beading is effectively inhibited.

### Poor Water-Soluble Alkanediol

The clear ink composition according to an aspect of the invention contains a poor water-soluble alkanediol.

According to a preferred aspect of the invention, the poor water-soluble alkanediol is preferably an alkanediol having 7 or more carbon atoms, more preferably an alkanediol having 7 to 10 carbon atoms, and most preferably a poor water-soluble 1,2-alkanediol and can effectively inhibit beading. Examples of the poor water-soluble 1,2-alkanediol include 1,2-heptanediol, 1,2-octanediol, 5-methyl-1,2-hexanediol, 4-methyl-1,2-hexanediol, and 4,4-dimethyl-1,2-pentanediol. In particular, 1,2-octanediol is preferred.

According to a preferred aspect of the invention, the content of the poor water-soluble alkanediol may be appropriately determined in a range that can efficiently inhibit beading of the ink, but is preferably 1.0 to 5.0% by mass, more preferably 1.5 to 4.0% by mass, and most preferably 2.0 to 3.5% by mass based on the total mass of the composition. An amount of the poor water-soluble alkanediol within the above-mentioned range, especially, an amount not less than the lower limit, can sufficiently inhibit occurrence of beading. In addition, an amount of the poor water-soluble alkanediol within the above-mentioned range, especially, an amount not higher than the upper limit, can prevent the initial viscosity of the ink from becoming too high and can effectively avoid separation of an oil layer under usual ink storage conditions, and is therefore preferred from the viewpoint of ink storage stability.

### Poly(Oxyalkylene Glycol)

The clear ink composition according to an aspect of the invention contains a poly(oxyalkylene glycol).

The poly(oxyalkylene glycol) contained in the clear ink composition according to an aspect of the invention is preferably a water miscible oligomer obtained by addition polymerization of ethylene oxide and/or propylene oxide. According to a preferred aspect of the invention, the poly(oxyalkylene glycol) is more preferably one or more selected from the group consisting of ethylene glycol, diethylene glycol, triethylene glycol, propylene glycol, dipropylene glycol, and tripropylene glycol, and more preferably one or more selected from the group consisting of triethylene glycol, propylene glycol, dipropylene glycol, and tripropylene glycol. According to a preferred aspect of the invention, the poly(oxyalkylene glycol) is more preferably a water miscible poly(propylene glycol). The poly(propylene glycol) is not particularly limited, but tripropylene glycol (CAS No. 24800-44-0) is more preferred from the viewpoint of its low moisture absorbency.

In an aspect of the invention, the amount of the poly(oxyalkylene glycol) may be appropriately determined in a range that can efficiently inhibit bleeding and beading of the ink, but is preferably 2.0 to 18.0% by mass and more preferably 6.0 to 18.0% by mass based on the total mass of the ink composition. An amount of the poly(oxyalkylene glycol) within the above-mentioned range, especially, an amount not lower than the lower limit, can maintain the poor water-soluble alkanediol in a mixed state without causing separation in the drying process of ink droplets and is therefore preferred. An amount of the poly(oxyalkylene glycol) within the above-mentioned range, especially, an amount not higher than the upper limit, can prevent the initial viscosity of the ink from becoming too high and can effectively avoid separation of an oil layer under usual ink storage conditions and is therefore preferred from the viewpoint of ink storage stability, and also such an amount can prevent occurrence of an incompatible state and is therefore preferred from the viewpoint of gloss.

In addition, the poly(oxyalkylene glycol) contained in the clear ink composition according to an aspect of the invention is hardly dried even if it is left under high temperature and low humidity and can also advantageously improve the recovery property from clogging of a nozzle under an open environment of 15% relative humidity (RH) at 50° C.

Furthermore, the sum of the content of the poor water-soluble alkanediol and the content of the poly(oxyalkylene glycol) is preferably 22.0% by mass or less, more preferably 16.0% by mass or less, and most preferably 10.0% by mass or less based on the total mass of the ink composition. In this range, the initial viscosity of the ink can be lowered, and the recovery property from clogging under an open environment at high temperature and low humidity can be appropriately adjusted without causing beading on a recording medium having low ink absorbability, such as printing paper.

### Crystalline Carbohydrate

The ink composition according to an aspect of the invention contains a crystalline carbohydrate that is solid at 20° C. The carbohydrate that can be preferably used in an aspect of the invention has low moisture absorbency, specifically, low moisture absorbency allowing the carbohydrate to be stably present in a powder state under an environment of 20° C. and 60% RH. It is generally known that a carbohydrate having lower moisture absorbency has a higher crystallization property. Accordingly, the term “crystalline carbohydrate” in the invention means a carbohydrate having the above-described physical properties. Therefore, the carbohydrate may be a carbohydrate having the above-described low moisture absorbency and does not refer to a carbohydrate always having a crystallinity of 100%.

The crystalline carbohydrate is not particularly limited as long as it can achieve the effects of the invention, but is preferably one or more selected from the group consisting of maltitol, sorbitol, xylitol, erythritol, trehalose, isotrehalose, neotrehalose, and sucrose, and more preferably one or more selected from the group consisting of trehalose, isotrehalose, neotrehalose, and sucrose. Furthermore, the crystalline carbohydrate may be a tri- or higher saccharide in which one or more of monosaccharides and disaccharides selected from the group consisting of maltose, maltitol, sorbitol, xylitol, erythritol, trehalose, isotrehalose, neotrehalose, and sucrose are bonded to each other or to another saccharide.

Trehalose is a nonreducing disaccharide in which 1-positions of two glucose molecules are linked to each other by a glucoside bond. Since trehalose is a nonreducing saccharide, brown discoloration by a Maillard reaction does not occur. Therefore, trehalose is preferred from the viewpoint of ink storage stability. In addition, it has characteristics that solubility in water and water-holding capacity are high and that moisture absorbency is significantly low. Specifically, high-purity anhydrous trehalose has very high solubility in water (69 g/100 g (20° C.)), but does not absorb moisture at 95% RH or less. Therefore, when trehalose is brought into contact with water, it absorbs the water to become a gel, but under an ordinary environment (about 20° C. and about 45% RH), trehalse does not absorb moisture and can be stably present. In addition, trehalose is preferred from the viewpoint of not reacting with amino group-containing resins.

Isotrehalose, neotrehalose, and sucrose are nonreducing disaccharides having glycoside bonds. Since they are nonreducing disaccharides, brown discoloration by a Maillard reaction does not occur. Accordingly, they are preferred from the viewpoint of ink storage stability.

The crystalline carbohydrate can be produced by a common method. That is, it is possible to produce the crystalline carbohydrate by, for example, spraying and drying a massecuite, i.e., a solution containing carbohydrate; removing water in a massecuite by natural dry to crystallize and solidify the carbohydrate in a block shape and pulverizing the solid; or recrystallizing the carbohydrate from a massecuite in a melted state using a seed crystal. The massecuite to be used may be any carbohydrate that can be produced into a crystalline carbohydrate to provide low absorbency described above and may contain two or more types of carbohydrates.

When a clear ink composition containing such a crystalline carbohydrate and a color ink composition are used for printing, beading caused by flowage spots that particularly occur in printing with a short difference in ink landing time can be inhibited. The reason thereof is not clear, but, for example, it can be assumed as follows. Since the crystalline carbohydrate contained in the clear ink composition adhering to a recording medium has high solubility in water and high water-holding capacity, it can gelate (or solidify) by taking in a large amount of water contained in the clear ink composition after the ink landing. Then, when a color ink droplet comes into contact with the clear ink surface in the gel (or solid) form, the carbohydrate absorbs water contained in the color ink to inhibit the fluidity (flowage spot) of the color ink droplet. Therefore, color ink droplets that come into contact with already landed ink droplets are hardly affected by the already landed color ink droplets. As a result, flowage spots are inhibited even in multicolor printing, and beading hardly occurs. Furthermore, it is assumed that the osmotic pressure is increased by the large amount of the water-soluble sugar, according to van't Hoff's law, to increase the permeation rate.

The recorded matter obtained by using an ink composition containing such a crystalline carbohydrate can be improved in dew condensation resistance in a high humidity environment of about 20° C. and about 60% RH.

The clear ink composition containing such a crystalline carbohydrate can have an improved recovery property from clogging under a close environment at high temperature and ordinary humidity. The reason thereof is not clear, but it is assumed that since the crystalline carbohydrate has significantly low moisture absorbency, waste ink remaining in a cap does not seize moisture from the meniscus ink in a nozzle, resulting in an excellent recovery property from clogging in the state in which the cap is sealed.

Furthermore, since the ink composition containing such a crystalline carbohydrate prevents ice crystals from growing, low-temperature storage stability of the ink can be improved.

According to a preferred aspect of the invention, the amount of the crystalline carbohydrate may be appropriately determined in a range that the above-described effects can be achieved, but is preferably 12.0 to 36.0% by mass and more preferably 18.0 to 30.0% by mass based on the total mass of the ink composition. An amount of the crystalline carbohydrate within the above-mentioned range, especially, an amount not lower than the lower limit, improves the recovery property from clogging under a close environment at high temperature and ordinary humidity and is therefore preferred, and such an amount is also preferred from the viewpoint of gloss. An amount of the crystalline carbohydrate within the above-mentioned range, especially, an amount not higher than the upper limit, prevents the initial viscosity of the ink from becoming too high and decreases the freezing temperature of the ink and is therefore preferred from the viewpoint of low-temperature storage stability of the ink. In addition, even when printing is performed on thin printing paper having a paper weight of 73.3 g/m² or less or on a PPC sheet (plain paper), rolling inward of the printed face, that is, so-called curling, can be significantly inhibited from occurring. The reason thereof is not clear, but it is assumed as follows. Cellulose is a saccharide having a long chain in which monosaccharides are linked (polymerized). Curling is caused by that hydrogen bonds between cellulose molecules are cleaved by water molecules and, during evaporative drying of the water, the hydrogen bonds are reformed between the cellulose molecules at positions differing from the positions where the hydrogen bonds were cleaved. Therefore, curling can be inhibited from occurring by blocking the reformation of the hydrogen bonds between cellulose molecules as quickly as possible after the water has been evaporated and dried. An effective material as the inhibitor is a crystalline carbohydrate having a molecular structure similar to that of the cellulose and is more preferably trehalose, isotrehalose, neotrehalose, and sucrose, which have excellent drying property and recrystallizing property.

Furthermore, according to a preferred aspect of the invention, the content ratio of the poor water-soluble alkanediol to the crystalline carbohydrate is preferably 1:3 to 1:36 and more preferably 1:4 to 1:18. Within this range, beading when ink droplet landing intervals are short can be inhibited.

The ratio of the sum of contents of the poly(oxyalkylene glycol) and the crystalline carbohydrate to the content of the poor water-soluble alkanediol is preferably 9:2 to 54:1. Within this range, recovery properties from clogging under an open environment at high temperature and low humidity and under a close environment at high temperature and ordinary humidity can be ensured. The reason thereof is not clear, but it is assumed to be due to a good balance between the water evaporation-inhibiting effect of the poly(oxyalkylene glycol) and the moisture absorption-blocking effect of the crystalline carbohydrate.

A recorded matter having excellent gloss can be obtained without causing beading, even when ink droplet landing intervals are short, by adjusting the content ratio within the above-mentioned range. The reason thereof is not clear, but it is assumed to be due to a good balance between the poor water-soluble alkanediol-mixing and dissolving effect of the poly(oxyalkylene glycol) and the flowage spot-inhibiting effect due to an increase in the solid content of the crystalline carbohydrate.

Furthermore, the sum of the content of the poor water-soluble alkanediol and the content of the crystalline carbohydrate is preferably 40.0% by mass or less, more preferably 16.0% by mass or less, based on the total mass of the ink composition. In this range, the initial viscosity of the ink can be lowered, and the recovery property from clogging under a close environment at high temperature and ordinary humidity can be appropriately adjusted without causing beading on a recording medium having low ink absorbability, such as printing paper.

Furthermore, the sum of the contents of the poor water-soluble alkanediol, the poly(oxyalkylene glycol), and the crystalline carbohydrate is preferably 58.0% by mass or less based on the total mass of the ink composition. In this range, the initial viscosity of the ink can be lowered, and the recovery properties from clogging under an open environment at high temperature and low humidity and under a close environment at high temperature and ordinary humidity can be appropriately adjusted without causing beading on a recording medium having low ink absorbability, such as printing paper.

Furthermore, according to a preferred aspect of the invention, the ink composition contains water in an amount at least equal to the content of the crystalline carbohydrate. Water contained in an amount at least equal to the content of the crystalline carbohydrate can maintain the crystalline carbohydrate in a dissolved state at ordinary temperature. In addition, the content of water is preferably 30% by mass or more and 74% by mass or less based on the total mass of the ink composition, and the ratio of the sum of the contents of the crystalline carbohydrate and the poly(oxyalkylene glycol) to the content of water is preferably 5:3 to 1:4. Such a range is preferred from the viewpoints that the crystalline carbohydrate can be inhibited from precipitating in the ink composition and the carbohydrate can rapidly precipitate on a recording medium.

### Amino Group-Containing Resin

The clear ink composition of the invention contains an amino group-containing resin.

In the ink composition of the invention, it is preferable that the aqueous solution of the amino group-containing resin be alkaline and that the amino group do not form a salt. The reason why a high-quality image being free from beading and bleeding can be obtained by using the clear ink containing the amino group-containing resin of the invention is not clear, but it is assumed as follows. An aqueous solution of an amino group-containing resin in which the amino group forms a salt with an acid such as hydrochloric acid or sulfonic acid shows acidity depending on the type of the acid that forms the salt. If such an amino group-containing resin is brought into contact with an ink composition in which a colorant is dispersed by making the ink composition alkaline, an aggregation reaction drastically proceeds to cause separation of the colorant and solidification.

If the aggregation reaction causes solidification in a path (e.g., ink absorber, waste liquid passage, or waste liquid tank) of waste liquid, the path of waste liquid is blocked, which is disadvantageous from the viewpoint of waste liquid treatment performance. If the aggregation reaction occurs on a recording medium, the aggregated solid inhibits permeation of water to the crystalline carbohydrate, which is disadvantageous from the viewpoint of beading.

On the contrary, if the amino group-containing resin is alkaline, the aggregation reaction gradually proceeds not to inhibit water from permeating into the crystalline carbohydrate, which is preferred from the viewpoint of beading. Since the degree of the aggregation is so small and does not inhibit the fluidity of the alkaline ink containing a colorant, the alkalinity is preferred from the viewpoint of waste liquid treatment performance.

As the amino group-containing resin, those described in Japanese Patent Nos. 4144487, 4240375, 4281393, and 4239152 can be used. In particular, the modified polyallylamine described in Japanese Patent No. 4144487 makes the diameters of dots on a recording medium small and is excellent in waste liquid treatment and is therefore preferred from these viewpoints. Furthermore, as another more preferred aspect of the amino group-containing resin, the carbamoyl-modified polyallylamines described in Japanese Patent Nos. 4240375 and 4281393 also can be used. The modified polyallylamines will be described in detail below.

### Modified Polyallylamine

In the explanation of the modified polyallylamine in the specification, the alkyl group as a group or a part of a group of the modified polyallylamine may be a linear chain or a branched chain.

The amino group-containing resin contained in the clear ink composition according to an aspect of the invention is preferably a modified polyallylamine, and the modified polyallylamine is a polyallylamine of which raw material is a copolymer (hereinafter referred to as copolymer as raw material) including essential structural components composed of diallylalkylamine monomer units represented by the repeating unit (a) and allylamine monomer units represented by the repeating unit (c) and an optional component composed of dialkylallylamine monomer units represented by the repeating unit (b) shown below. Thus, in the modified polyallylamine, the amino groups of the allylamine monomers are modified by substituents shown below.

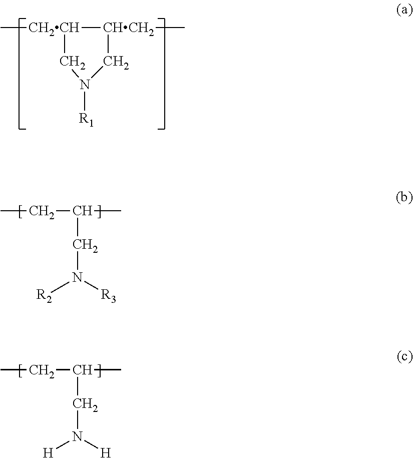

In the formulae, R₁, R₂, and R₃ each independently represent an alkyl group having 1 to 4 carbon atoms and, in particular, preferably a methyl group.

In the modified polyallylamine that is used in the invention, at least one of hydrogen atoms of —NH₂ in the allylamine repeating unit (c) is substituted by any one of the following (i) to (v).

That is, examples of the substituent include (i) —CONH₂ (hereinafter referred to as urea-modified polyallylamine), (ii) —COOR₂ (hereinafter referred to as urethane-modified polyallylamine), (iii) —COR₃ (hereinafter referred to as acyl-modified polyallylamine), (iv) —CH₂CH(R₄)-A (hereinafter referred to as Michael-modified polyallylamine), and (v) —CH₂CH(OH)—B (hereinafter referred to as alcohol-modified polyallylamine).

Each modified polyallylamine in the invention will be described below.

### (i) Urea-Modified Polyallylamine

The urea-modified polyallylamine is a copolymer of the following repeating units (a), (b), (c), and (d1).

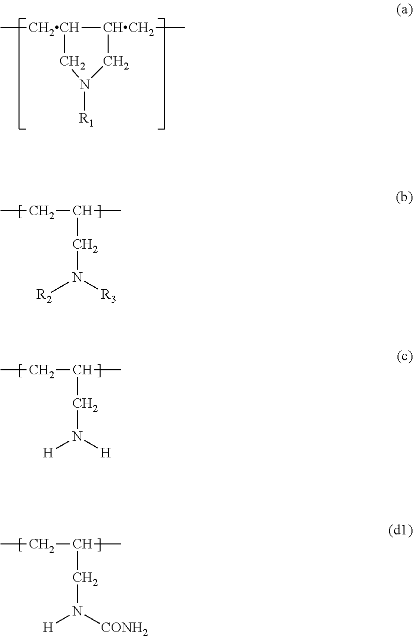

In the formulae, R₁, R₂, and R₃ each independently represent an alkyl group having 1 to 4 carbon atoms and, in particular, preferably a methyl group.

The proportion of the number of the repeating units (a) to the total number of the structural monomer units (a) and (b) constituting the modified polyallylamine is preferably 0 to 90% and more preferably 0 to 80%. The proportion of the number of the repeating units (a) and (b) to the total number of monomers constituting the modified polyallylamine is preferably 5 to 95%, more preferably 10 to 90%, and particularly preferably 20 to 80%. On this occasion, the degree of carbamoylation, that is, the proportion of the number of the repeating units (d1) to the total number of the repeating units (c) and (d1) is preferably 60 to 100%, more preferably 90 to 100%, and particularly preferably 95 to 100% from the viewpoints of solubility and stability of the modified polyallylamine.

### (ii) Urethane-Modified Polyallylamine

The urethane-modified polyallylamine is a copolymer of the following repeating units (a), (b), (c), and (d2).

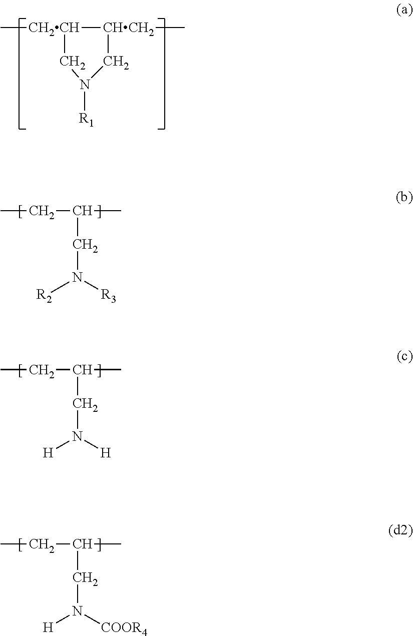

In the formulae, R₁, R₂, and R₃ each independently represent an alkyl group having 1 to 4 carbon atoms and, in particular, preferably a methyl group; and R₄ represents an alkyl group having 1 to 12 carbon atoms or an aryl group having 6 to 12 carbon atoms.

As the alkyl group having 1 to 12 carbon atoms for R₄, a linear alkyl group having 1 to 4 carbon atoms, such as a methyl group, an ethyl group, a propyl group, or a butyl group, is preferred. As the aryl group having 6 to 12 carbon atoms, a phenyl group, an o-tolyl group, an m-tolyl group, and a p-tolyl group are exemplified.

The proportion of the number of the repeating units (a) to the total number of the structural monomer units (a) and (b) constituting the modified polyallylamine is preferably 0 to 90% and more preferably 0 to 80%. In addition, the proportion of the number of the repeating units (a) and (b) to the total number of monomers constituting the modified polyallylamine is preferably 5 to 95%, more preferably 10 to 90%, and particularly preferably 20 to 80%. On this occasion, the degree of alkoxycarbonylation (or aryloxycarbonylation), that is, the proportion of the number of the repeating units (d2) to the total number of the repeating units (c) and (d2) is preferably 60 to 100%, more preferably 90 to 100%, and particularly preferably 95 to 100% from the viewpoints of solubility and stability of the modified polyallylamine.

(iii) Acyl-Modified Polyallylamine

The acyl-modified polyallylamine is a copolymer of the following repeating units (a), (b), (c), and (d3).

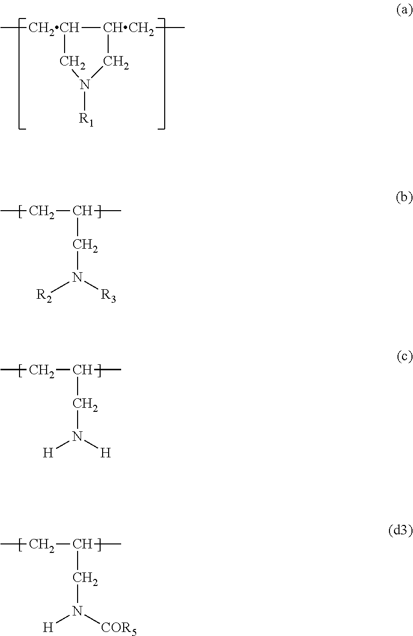

In the formulae, R₁, R₂, and R₃ each independently represent an alkyl group having 1 to 4 carbon atoms and, in particular, preferably a methyl group; and R₅ represents an alkyl group having 1 to 12 carbon atoms and is preferably a methyl group, an ethyl group, an n-propyl group, an i-propyl group, an n-butyl group, an n-pentyl group, an n-hexyl group, an n-heptyl group, or an n-nonyl group.

The proportion of the number of the repeating units (a) to the total number of the structural monomer units (a) and (b) constituting the modified polyallylamine is preferably 0 to 90% and more preferably 0 to 80%. In addition, the proportion of the number of the repeating units (a) and (b) to the total number of monomers constituting the modified polyallylamine is preferably 5 to 95%, more preferably 10 to 90%, and particularly preferably 20 to 80%. On this occasion, the degree of acylation, that is, the proportion of the number of the repeating units (d3) to the total number of the repeating units (c) and (d3) is preferably 60 to 100%, more preferably 90 to 100%, and particularly preferably 95 to 100% from the viewpoints of solubility and stability of the modified polyallylamine.

### (iv) Michael-Modified Polyallylamine

The Michael-modified polyallylamine is a copolymer of the following repeating units (a), (b), (c), and (d41) and/or (d42).

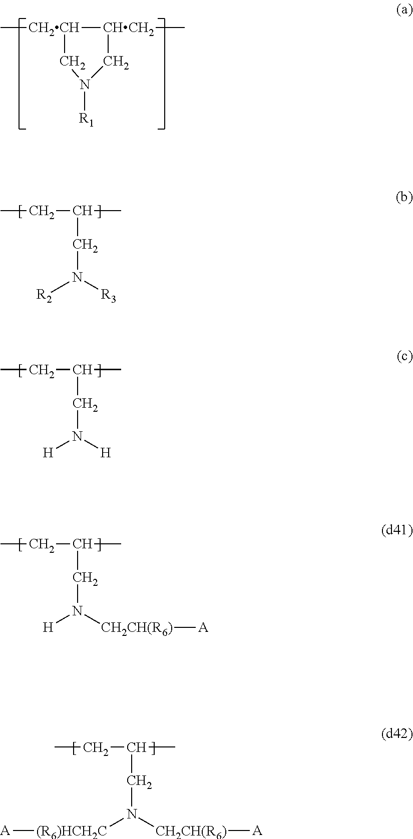

In the formulae, R₁, R₂, and R₃ each independently represent an alkyl group having 1 to 4 carbon atoms and, in particular, preferably a methyl group; R₆ represents a hydrogen atom or a methyl group; and A is selected from the group consisting of —CONR₇R₈ (R₇ and R₈ each independently represent a hydrogen atom or an alkyl group having 1 to 8 carbon atoms (the alkyl group may be substituted by a group selected from the group consisting of hydroxy groups, keto groups, monoalkylamino groups having 1 to 4 carbon atoms, di(alkyl having 1 to 4 carbon atoms)amino groups, and tri(alkyl having 1 to 4 carbon atoms)ammonium groups), or NR₇R₈ represents a cyclic amino group of a piperidino group or a morpholino group as a whole), —CN, and COOR₉ (wherein R₉ represents an alkyl group having 1 to 8 carbon atoms (the alkyl group may be substituted by a group selected from the group consisting of hydroxy groups, keto groups, monoalkylamino groups having 1 to 4 carbon atoms, di(alkyl having 1 to 4 carbon atoms)amino groups, and tri(alkyl having 1 to 4 carbon atoms)ammonium groups)).

The group —CH₂CH(R₆)-A is usually a Michael reaction adduct of an acrylic compound. When the group is an acrylamide adduct type (i.e., A is a —CONR₅R₆ type), examples thereof include —CH₂CH₂CONH₂, —CH₂CH₂CONHCH₃, —CH₂CH₂CON(CH₃)₂, —CH₂CH₂CONHC₂H₅, —CH₂CH₂CON(C₂H₅)₂, —CH₂CH₂CONH-nC₃H₇, —CH₂CH₂CON(nC₃H₇)₂, —CH₂CH₂CONH-iC₃H₇, —CH₂CH₂CONHCH₂O-nC₄H₉, —CH₂CH₂CONHCH₂OH, —CH₂CH₂CONHCH₂CH₂N(CH₃)₂, —CH₂CH₂CONHCH₂CH₂N(C₂H₅)₂, —CH₂CH₂CONHCH₂CH₂CH₂N(CH₃)₂, —CH₂CH₂CONHCH₂CH₂CH₂N(C₂H₅)₂, CH₂CH₂CONHCH₂CH₂N⁺(CH₃)₃, —CH₂CH₂CONHCH₂CH₂N⁺(C₂H₅)₃, —CH₂CH₂CONHCH₂CH₂CH₂N⁺(CH₃)₃, —CH₂CH₂CONHCH₂CH₂CH₂N⁺(C₂H₅)₃, —CH₂CH₂CO-morpholino group, —CH₂CH₂CO-piperidino group, —CH₂CH(CH₃)CONH₂, —CH₂CH(CH₃)CONHCH₃, —CH₂CH(CH₃)CON(CH₃)₂, —CH₂CH(CH₃)CONHC₂H₅, —CH₂CH(CH₃)CON(C₂H₅)₂, —CH₂CH(CH₃)CONH-nC₃H₇, —CH₂CH(CH₃)CON(nC₃H₇)₂, CH₂CH(CH₃) CONH-iC₃H₇, —CH₂CH(CH₃)CONHCH₂O-nC₄H₉, —CH₂CH(CH₃)CONHCH₂OH, —CH₂CH(CH₃)CONHCH₂CH₂N(CH₃)₂, —CH₂CH(CH₃)CONHCH₂CH(CH₃)N(C₂H₅)₂, —CH₂CH(CH₃)CONHCH₂CH₂CH₂N(CH₃)₂, —CH₂CH(CH₃)CONHCH₂CH₂CH₂N(C₂H₅)₂, —CH₂CH(CH₃)CONHCH₂CH₂N⁺(CH₃)₃, —CH₂CH(CH₃)CONHCH₂CH₂N⁺(C₂H₅)₃, —CH₂CH(CH₃)CONHCH₂CH₂CH₂N⁺(CH₃)₃—CH₂CH(CH₃)CONHCH₂CH₂CH₂N⁺(C₂H₅)₃, —CH₂CH(CH₃)CO-morpholino group, and —CH₂CH(CH₃)CO-piperidino group.

When the group —CH₂CH(R₆)-A is an acrylonitrile adduct type, examples thereof include —CH₂CH₂CN and —CH₂CH(CH₃)CN.

When the group —CH₂CH(R₆)-A is an acrylate adduct type, examples thereof include —CH₂CH₂COOCH₃, —CH₂CH₂COOC₂H₅, —CH₂CH₂COOC₃H₇, —CH₂CH₂COOC₄H₉, —CH₂CH₂COOCH₂CH₂N(CH₃)₂, —CH₂CH₂COOCH₂CH₂CH₂N(CH₃)₂, —CH₂CH₂COOCH₂CH₂N(C₂H₅)₂, —CH₂CH₂COOCH₂CH₂CH₂N(C₂H₅)₂, —CH₂CH₂COOCH₂CH₂CH₂N⁺(CH₃)₃, —CH₂CH₂COOCH₂CH₂N⁺(C₂H₅)₃, and CH₂CH₂COOCH₂CH₂CH₂N⁺(C₂H₅)₃.

The proportion of the number of the repeating units (a) to the total number of the structural monomer units (a) and (b) constituting the modified polyallylamine is preferably 0 to 90% and more preferably 0 to 80%. In addition, the proportion of the number of the repeating units (a) and (b) to the total number of monomers constituting the modified polyallylamine is preferably 5 to 95%, more preferably 10 to 90%, and particularly preferably 20 to 80%. On this occasion, the degree of conversion into a Michael adduct, that is, the proportion of the number of the repeating units (d41) and/or (d42) to the total number of the repeating units (c) and (d41) and/or (d42) is preferably 60 to 100%, more preferably 90 to 100%, and particularly preferably 95 to 100% from the viewpoints of solubility and stability of the modified polyallylamine.

The proportion of the number of the repeating units (d42) to the total number of the repeating units (d41) and (d42) is preferably 60 to 100%, more preferably 90 to 100%, and most preferably 95 to 100% from the viewpoint of waste liquid treatment.

### (v) Alcohol-Modified Polyallylamine

The alcohol-modified polyallylamine is a copolymer of the following repeating units (a), (b), (c), and (d51) and/or (d52).

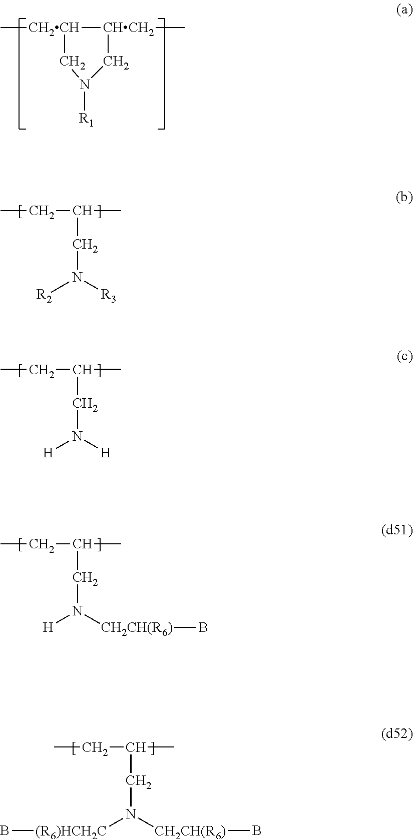

In the formulae, R₁, R₂, and R₃ each independently represent an alkyl group having 1 to 4 carbon atoms and, in particular, preferably a methyl group; and B represents an alkyl group having 1 to carbon atoms (the alkyl group may be substituted by a group selected from the group consisting of hydroxy groups, alkoxy groups having 1 to 4 carbon atoms, and alkenyloxy groups).

B is a hydroxy group, an alkyloxy group having 1 to 4 carbon atoms, or an alkyl group having 1 to 8 carbon atoms (the alkyl group may be substituted by an alkenyloxy group), and specific examples thereof include a methyl group, an ethyl group, a propyl group, a butyl group, a pentyl group, a hexyl group, a methoxymethyl group, an ethoxymethyl group, a propyloxymethyl group, a butoxymethyl group, a pentoxymethyl group, a hydroxymethyl group, and a (2-propenyloxy)methyl group.

Examples of the group —CH₂CH(R₆)—B include a 2-hydroxypropyl group, a 2-hydroxybutyl group, a 2-hydroxypentyl group, a 2-hydroxyhexyl group, hydroxyheptyl group, a 2-hydroxyoctyl group, a 3-methoxy-2-hydroxypropyl group, a 3-ethoxy-2-hydroxypropyl group, a 3-propyloxy-2-hydroxypropyl group, a 3-(i-propyloxy)-2-hydroxypropyl group, a 3-butoxy-2-hydroxypropyl group, a 3-pentoxy-2-hydroxypropyl group, a 2,3-dihydroxypropyl group, and a 3-(2-propenyl)-2-hydroxypropyl group.

The proportion of the number of the repeating units (a) to the total number of the structural monomer units (a) and (b) constituting the modified polyallylamine is preferably 0 to 90% and more preferably 0 to 80%. In addition, the proportion of the number of the repeating units (a) and (b) to the total number of monomers constituting the modified polyallylamine is preferably 5 to 95%, more preferably 10 to 90%, and particularly preferably 20 to 80%. On this occasion, the degree of conversion into a hydroxyalkyl, that is, the proportion of the number of the repeating units (d51) and/or (d52) to the total number of the repeating units (c) and (d51) and/or (d52) is preferably 60 to 100%, more preferably 90 to 100%, and particularly preferably 95 to 100% from the viewpoints of solubility and stability of the modified polyallylamine according to an aspect of the invention.

The proportion of the number of the repeating units (d52) to the total number of the repeating units (d51) and (d52) is preferably 60 to 100%, more preferably 90 to 100%, and particularly preferably 95 to 100% from the viewpoint of waste liquid treatment.

The structure of the modified polyallylamine has been described above, but when a plurality of monomer units of modified allylamines is present, the monomer units may be the same type or a plurality of different types.

The weight-average molecular weight of the modified polyallylamine is preferably 12000 or less, more preferably 200 or more and 12000 or less, more preferably 200 or more and 8000 or less, and most preferably 1000 or more and 5000 or less. A molecular weight of 12000 or less can realize suitable solubility of the modified polyallylamine in an organic solvent. On the other hand, a molecular weight of 200 or more can improve the performance of a recorded matter when the ink composition is applied to an ink jet recording system. In the specification, the term “weight-average molecular weight” means a molecular weight in terms of polyethylene glycol measured by gel permeation chromatography (GPC).

The above-described copolymer as a raw material can be synthesized by, for example, the following method.

The copolymer as a raw material can be produced by polymerization of an aqueous solution containing monomers of a diallylalkylamine and a monoallylamine as essential components and a dialkylallylamine as an optional component in the presence of a polymerization initiator. In this case, the concentration of the monomers in the aqueous solution is 10 to 80% by mass and preferably 15 to 70% by mass. As the diallylalkylamine, methyldiallylamine is preferably used because of high solubility of a modified product thereof. The content of the dialkylallylamine as the optional component is preferably 0 to 90% and more preferably 0 to 80% based on the mass of the diallylalkylamine monomer.

As the polymerization initiator, a compound having a water-soluble azo group, such as 2,2′-azobis(2-amidinopropane)dihydrochloride, is preferably used. The amount of the polymerization initiator is preferably 0.1 to 30 mol % based on the total amount of the monomers. The polymerization time is preferably 3 to 100 hours and preferably 5 to 70 hours.

The weight-average molecular weight of the copolymer as the raw material is preferably 200 to 12000, more preferably 200 to 8000, and most preferably 300 to 5000. Within this range of the molecular weight, the produced modified polyallylamine is well dissolved in a solvent constituting ink, and the attacking properties on component parts of an ink jet recording apparatus are reduced. Thus, modified polyallylamine does not act on the ink passage-constituting parts and is therefore preferred.

The modified polyallylamine contained in the ink composition according to an aspect of the invention can be obtained as a copolymer of an N,N-dialkylallylamine and an N-substituted allylamine by modifying at least a part of hydrogen atoms of —NH₂ of an allylamine monomer in a copolymer as the raw material into “—NH-substituent” and/or “—N-di(substituent)” by letting the copolymer as the raw material react with a reagent that can replace the amino group with a substituent having 1 to 12 carbon atoms, for example, an N-carbamoylation reagent, an alkoxycarbonylation reagent, an allyloxycarbonylation reagent, an acylation reagent, or a 1,2-epoxyalkane compound optionally having an acrylic compound or substituent that can cause a Machael addition reaction.

In the invention, the content of the amino group-containing resin may be appropriately determined from the viewpoints of reduction in dot diameter of a recorded matter and waste liquid treatment, but according to a preferred aspect of the invention, the solid content is preferably 2.0 to 8.0% by mass.

The ink composition of the invention may further contain a polyethyleneimine or its derivative.

### Water-Soluble Alkanediol

According to a preferred aspect of the invention, the ink composition of the invention contains an amino group-containing resin, a poor water-soluble alkanediol, a crystalline carbohydrate that is solid at 20° C., and a poly(oxyalkylene glycol) and may also contain a water-soluble alkanediol. By doing so, occurrence of bleeding of the materials other than solid contents contained in the ink composition, that is, an aqueous solution including the solvent, can be advantageously further inhibited.

The water-soluble alkanediol in the invention is a both-end-type or one-end-type alkanediol. The water-soluble alkanediol of the invention is preferably an alkanediol having 3 or more carbon atoms and more preferably alkanediol having 3 to 6 carbon atoms. Preferred examples of the water-soluble alkanediol contained in the ink composition according to an aspect of the invention include water-soluble hexanediol such as 1,2-hexanediol and 1,6-hexanediol, 2-methyl-1,3-propanediol, and 3-methyl-1,5-pentanediol. Among them, 1,2-hexanediol and 3-methyl-1,5-pentanediol are particularly preferred. In addition, 1,6-hexanediol is excellent in discharge stability at high frequencies and, thereby, is also preferred. In the specification, the term “both-end-type alkanediol” means an alkanediol having a hydroxyl group on each of both ends of the main chain of an alkyl chain, and the term “one-end-type alkanediol” means an alkanediol having a hydroxyl group on one end of the main chain of an alkyl chain. Therefore, for example, 1,6-hexanediol and 3-methyl-1,5-pentanediol are both-end-type alkanediols, and 1,2-hexanediol is a one-end-type alkanediol.

Furthermore, according to a preferred aspect of the invention, the ratio of the content of the poor water-soluble alkanediol to the content of the water-soluble alkanediol is preferably 1:1 to 10:1 and more preferably 2:1 to 4:1. Within this range, beading that occurs when ink droplet landing intervals are short can be inhibited.

Furthermore, according to a preferred aspect of the invention, the sum of the content of the water-soluble alkanediol and the content of the crystalline carbohydrate is preferably 40.0% by mass or less and more preferably 28.0% by mass or less based on the total mass of the ink composition. Within this range, beading that occurs when ink droplet landing intervals are short can be inhibited.

Furthermore, according to a preferred aspect of the invention, the sum of the content of the water-soluble alkanediol and the content of the poly(oxyalkylene glycol) is preferably 22.0% by mass or less, more preferably 16.0% by mass or less, and most preferably 10.0% by mass or less based on the total mass of the ink composition. Within this range, bleeding that occurs when ink droplet landing intervals are short can be inhibited.

Furthermore, the sum of the content of the poly(oxyalkylene glycol), the content of the water-soluble alkanediol, and the content of the poor water-soluble alkanediol is preferably 26.0% by mass or less, more preferably 20.0% by mass or less, and most preferably 14.0% by mass or less based on the total mass of the ink composition. Within this range, bleeding that occurs when ink droplet landing intervals are short can be inhibited.

Furthermore, the sum of the content of the crystalline carbohydrate, the content of the water-soluble alkanediol, and the content of the poor water-soluble alkanediol is preferably 16.0% by mass or more and 40.0% by mass or less and more preferably 16.0% by mass or more and 32.0% by mass or less based on the total mass of the ink composition. Within this range, beading that occurs when ink droplet landing intervals are short can be inhibited.

Furthermore, according to a preferred aspect of the invention, the amount of the water-soluble alkanediol may be appropriately determined as long as bleeding and beading of ink can be efficiently inhibited, but is preferably 0.1 to 4.0% by mass, more preferably 0.5 to 3.0% by mass, and most preferably 1.0 to 2.0% by mass based on the total mass of the composition. An amount of the water-soluble alkanediol within the above-mentioned range, especially, an amount not lower than the lower limit, can sufficiently inhibit the occurrence of bleeding. In addition, an amount of the water-soluble alkanediol within the above-mentioned range, especially, an amount not higher than the upper limit, can prevent the initial viscosity of the ink from becoming too high and can effectively avoid separation of an oil layer under usual ink storage conditions, and is therefore preferred from the viewpoint of ink storage stability. Furthermore, when 1,2-hexanediol, which is a preferred example of the water-soluble alkanediol, is contained in an amount of 0.1 to 4.0% by mass based on the total mass of the composition, a higher-quality image being free from bleeding and beading can be formed. 1,2-Hexanediol is also effective as a regulator when discharge performance varies depending on the type of the pigment or the amount of the resin.

According to a preferred aspect of the invention, it is preferable that, based on the total mass of the ink composition, the content of the poly(oxyalkylene glycol) be 6% by mass or more and 18% by mass or less, the content of the crystalline carbohydrate be 12% by mass or more and 36% by mass or less, and the content of water be 30% by mass or more and 74% by mass or less and also that the ratio of the sum of the contents of the poly(oxyalkylene glycol) and the crystalline carbohydrate to the content of the water be 5:3 to 1:4. Such a range is preferred from the viewpoints that the crystalline carbohydrate can be inhibited from precipitating in the ink composition and that the carbohydrate can rapidly precipitate on a recording medium.

According to a preferred aspect of the invention, it is preferable that, based on the total mass of the ink composition, the content of the poor water-soluble alkanediol be 1.0% by mass or more and 5.0% by mass or less, and the content of the water-soluble alkanediol be 0.1% by mass or more and 4.0% by mass or less and also that the ratio of the content of the poor water-soluble alkanediol to the content of the water-soluble alkanediol be 1:1 to 10:1. Within this range, beading that occurs when ink droplet landing intervals are short can be inhibited.

### Other Solvent

According to a preferred aspect of the invention, the ink composition may further contain triethylene glycol monomethyl ether. By containing 0.1 to 4% by mass of triethylene glycol monomethyl ether, clogging in the ink cap for capping an ink jet head can be inhibited. In the specification, the term “clogging in the ink cap” means that waste liquid remaining in the cap is solidified by drying and clogs the micropores of an ink absorber, such as nonwoven fabric, in the ink cap. By inhibiting clogging in the ink cap, a reduction in success rate of cleaning can be prevented, and the recovery property from nozzle clogging can be improved.

### Surfactant

The clear ink composition according to an aspect of the invention may contain a surfactant. When a surfactant is contained, bleeding can be controlled. Therefore, an image excellent in expressing thin lines can be formed on a recording medium having a surface of a fiber layer for receiving ink, such as plain paper. Especially, even when a recording medium having an application layer for receiving oil-based ink as the receiving layer of the surface, such as printing paper, is used, bleeding between colors can be prevented, and also whitening due to reflected light, which occurs with an increase in the amount of adhering ink, can be prevented.

The surfactant used in an aspect of the invention is preferably a polyorganosiloxane-based surfactant, which can increase the permeability of ink by enhancing wettability to a recording medium surface, when a recording image is formed. When the polyorganosiloxane-based surfactant is used, since one type of the poor water-soluble alkanediol and one type of the poly(oxyalkylene glycol) described above are contained, the solubility of the surfactant in the ink is increased to inhibit occurrence of insoluble matters or the like, and thereby an ink composition excellent in discharge stability can be provided.

As the surfactant described above, a commercially available one may be used. For example, BYK-347 (BYK-Chemie) and BYK-348 (BYK-Chemie) can be used.

The polyorganosiloxane-based surfactant used as the surfactant in the invention is not particularly limited, but it is particularly preferable that an aqueous solution composed of 20% by mass of glycerin, 10% by mass of 1,2-hexanediol, 0.1% by mass of the polyorganosiloxane-based surfactant, and 69.9% by mass of water have a dynamic surface tension of not higher than 26 mN/m at 1 Hz. The dynamic surface tension can be measured using, for example, a bubble pressure dynamic surface tensiometer, BP-2 (manufactured by Kruss GmbH).

As the surfactant described above, a commercially available one may be used. For example, Olfine PD-501 (manufactured by Nissin Chemical Industry Co., Ltd.) and Olfine PD-570 (manufactured by Nissin Chemical Industry Co., Ltd.) can be used.

Furthermore, the polyorganosiloxane-based surfactant contains one or more compounds represented by the following Formula (I):

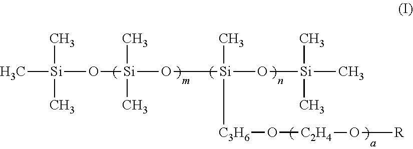

(in the formula, R represents a hydrogen atom or a methyl group, a represents an integer of 2 to 13, m represents an integer of 2 to 70, and n represents an integer of 1 to 8); preferably contains one or more compounds represented by Formula (I), wherein R represents a hydrogen atom or a methyl group, a represents an integer of 2 to 11, m represents an integer of 2 to 50, and n represents an integer of 1 to 5; more preferably contains one or more compounds represented by Formula (I), wherein R represents a hydrogen atom or a methyl group, a represents an integer of 2 to 13, m represents an integer of 2 to 50, and n represents an integer of 1 to 5; more preferably contains one or more compounds represented by Formula (I), wherein R represents a hydrogen atom or a methyl group, a represents an integer of 2 to 13, m represents an integer of 2 to 50, and n represents an integer of 1 to 8; more preferably contains one or more compounds represented by Formula (I), wherein R represents a methyl group, a represents an integer of 6 to 18, m represents an integer of 0 to 4, and n represents an integer of 1 or 2; and more preferably contains one or more compounds represented by Formula (I), wherein R represents a methyl group, a represents an integer of 6 to 18, m is 0, and n is 1. The use of such a specific polyorganosiloxane-based surfactant further reduces uneven aggregation of ink even in printing using printing paper as the recording medium.

Beading of ink can be further reduced by using a compound represented by Formula (I) wherein R is a methyl group. Furthermore, bleeding of ink can be further reduced by simultaneously using a compound represented by Formula (I) wherein R is a hydrogen atom.

In the compounds represented by Formula (I), by appropriately adjusting the blending proportions of the compound having R of a methyl group and the compound having R of a hydrogen atom, a high-quality image being free from bleeding and beading can be formed. In addition, the compounds are effective as regulators when fluidity varies depending on the type of the pigment and the amount of the resin.

The amount of the surfactant contained in the ink composition according to an aspect of the invention is preferably 0.01 to 1.0% by mass and more preferably 0.05 to 0.50% by mass. In particular, when the surfactant is the compound having R of a hydrogen atom, the amount thereof is preferably smaller than that when the surfactant is the compound having R of a methyl group, from the viewpoint of beading. When the surfactant having R of a hydrogen atom is contained in an amount of 0.01 to 0.1% by mass, water repellency is provided, and bleeding can be controlled.

In addition, a Gemini-type surfactant can be suitably used as the surfactant used in an aspect of the invention. The use of the Gemini-type surfactant in combination with the poor water-soluble alkanediol can uniformly disperse the poor water-soluble solvent, resulting in a reduction in the initial viscosity of ink. Therefore, the amounts of the color material, the clogging-preventing agent, and other additives contained in the ink composition can be increased, and, as a result, an image having excellent color development can be formed not only on plain paper but also on a recording medium having a porous surface on which a resin or particles for receiving ink is coated. Especially, even when a recording medium having an application layer for receiving oil-based ink as the receiving layer on the surface, such as printing paper, is used, bleeding between colors can be prevented, and also color density spots caused by ink flow among dots, which tends to occur with an increase in the amount of adhering ink, can be prevented. The reason thereof is not clear, but it is thought that the fluidity of the colorant is lost because that the Gemini-type surfactant has excellent orientation to form extremely stable oil gel with the poor water-soluble solvent. Accordingly, the addition of the Gemini-type surfactant is more effective when a larger amount of the poor water-soluble solvent is used. In the specification, the term “Gemini-type surfactant” means a surfactant having a structure in which two surfactant molecules are connected to each other via a linker.

The Gemini-type surfactant is preferably a two-chain/three-hydrophilic group-type surfactant having a structure in which the hydrophilic group portions of a couple of one-chain type surfactants are connected to each other via a linker having a hydrophilic group. Furthermore, the hydrophilic group portions of the one-chain-type surfactants are preferably acidic amino acid residues, and the linker is preferably a basic amino acid. A specific example is a surfactant having a structure in which a couple of one-chain-type surfactants having glutamic acid or aspartic acid as the hydrophilic group portions are connected to each other via a linker such as arginine, lysine, or histidine. The Gemini-type surfactant used in an aspect of the invention is preferably a surfactant represented by the following Formula (II):

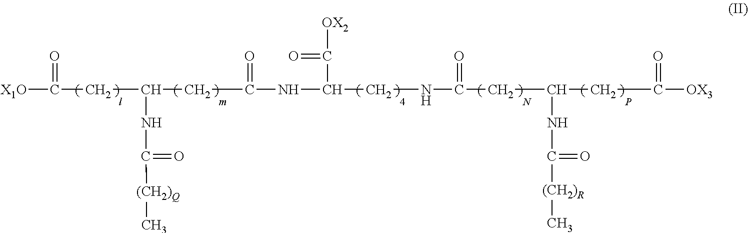

(in Formula (II), X₁, X₂, and X₃ each independently represent a hydrogen atom or an alkali metal, but do not simultaneously represent hydrogen atoms or alkali metals; L and M each independently represent 0 or 2, but do not simultaneously represent 0 or 2; N and P each independently represent 0 or 2, but do not simultaneously represent 0 or 2; Q and R each represent an integer of 8 to 18).

In Formula (II), the alkali metal is preferably Na, and Q and R are each preferably around 10. Examples of such compounds include sodium salts of condensates of N-lauroyl-L-glutamic acid and L-lysine. The compounds represented by the formula may be those that are commercially available. For example, Pellicer L-30 (manufactured by Asahi Kasei Chemicals Corp.), which is an aqueous solution containing 30% of a sodium salt of a condensate of N-lauroyl-L-glutamic acid and L-lysine, can be suitably used.

In an aspect of the invention, the use of the Gemini-type surfactant can enhance permeability of ink by increasing wettability of the ink to a recording medium surface when a recording image is formed. As a result, uneven aggregation of the ink is further reduced even when the recording medium is printing paper. In addition, since the ink composition according to an aspect of the invention contains the poor water-soluble alkanediol, the solubility of the surfactant in the ink is improved to inhibit generation of insoluble matters or the like. Therefore, an ink composition having more excellent discharge stability can be obtained.

The amount of the Gemini-type surfactant contained in the ink composition according to an aspect of the invention is preferably 0.01 to 1.0% by mass and more preferably 0.05 to 0.50% by mass.

The ink composition according to a preferred aspect of the invention can contain both the polyorganosiloxane-based surfactant and the Gemini-type surfactant. The ink composition according to an aspect of the invention containing both these two types of surfactants can realize a high-quality image being free from bleeding and beading, and also these surfactants are also effective as regulators when fluidity varies depending on the type of the pigment or the amount of the resin.

The clear ink composition according to an aspect of the invention may further contain another surfactant, such as an acetylene glycol-based surfactant, an anionic surfactant, a nonionic surfactant, or an ampholytic surfactant.

Among them, examples of the acetylene glycol-based surfactant include 2,4,7,9-tetramethyl-5-decyne-4,7-diol, 3,6-dimethyl-4-octyne-3,6-diol, 3,5-dimethyl-1-hexyn-3-ol, and 2,4-dimethyl-5-hexyn-3-ol. The acetylene glycol-based surfactant may be those that are commercially available, and examples thereof include Olfine E1010, STG, and Y (trade names, manufactured by Nissin Chemical Industry Co., Ltd.), Surfynol 61, 104, 82, 465, 485, and TG (trade names, manufactured by Air Products and Chemicals Inc.).

### Water and Other Components

The clear ink composition according to an aspect of the invention contains water. The water is preferably pure water or ultrapure water, such as deionized water, ultrafiltered water, reverse osmosis water, or distilled water. In particular, pure or ultrapure water subjected to sterilization with ultraviolet irradiation or addition of hydrogen peroxide can prevent occurrence of mold and bacteria over a long period of time and is therefore preferred.

Furthermore, the ink composition according to an aspect of the invention may contain a penetrant, in addition to the above-mentioned components.

As the penetrant, glycol ethers can be suitably used.

Specific examples of the glycol ethers include ethylene glycol monomethyl ether, ethylene glycol monoethyl ether, ethylene glycol mono-iso-propyl ether, ethylene glycol mono-n-butyl ether, ethylene glycol mono-iso-butyl ether, ethylene glycol mono-tert-butyl ether, ethylene glycol monomethyl ether acetate, diethylene glycol monomethyl ether, diethylene glycol monoethyl ether, diethylene glycol mono-n-propyl ether, diethylene glycol mono-iso-propyl ether, diethylene glycol mono-n-butyl ether, diethylene glycol mono-tert-butyl ether, triethylene glycol mono-n-butyl ether, propylene glycol monomethyl ether, propylene glycol monoethyl ether, propylene glycol mono-n-propyl ether, propylene glycol mono-iso-propyl ether, propylene glycol mono-n-butyl ether, propylene glycol mono-tert-butyl ether, dipropylene glycol monomethyl ether, dipropylene glycol monoethyl ether, dipropylene glycol mono-n-propyl ether, dipropylene glycol iso-propyl ether, dipropylene glycol mono-n-butyl ether, dipropylene glycol mono-tert-butyl ether, and 1-methyl-1-methoxybutanol. These may be used alone or as a mixture of two or more thereof.

Among the above-mentioned glycol ethers, preferred are alkyl ethers of polyols, and particularly preferred are ethylene glycol monoethyl ether, ethylene glycol mono-n-butyl ether, diethylene glycol monomethyl ether, diethylene glycol monoethyl ether, diethylene glycol mono-n-butyl ether, propylene glycol monomethyl ether, propylene glycol monoethyl ether, propylene glycol monobutyl ether, triethylene glycol monomethyl ether, triethylene glycol monoethyl ether, and triethylene glycol mono-n-butyl ether.

More preferred are triethylene glycol monomethyl ether and triethylene glycol mono-n-butyl ether.

The amount of the penetrant may be appropriately determined, but is preferably about 0.1 to 30% by mass and more preferably about 1 to 20% by mass.

Furthermore, the ink composition according to an aspect of the invention may contain a recording medium-dissolving agent, in addition to the above-mentioned components.

As the recording medium-dissolving agent, pyrrolidones, such as N-methyl-2-pyrrolidone, pyrrolidone carbonate, and alkali metal salts thereof, can be suitably used. In addition, glymes such as diethylene glycol diethylene ether, dipropylene glycol dimethyl ether, and dipropylene glycol diethyl ether and lactams such as γ-butyrolactone can be suitably used. The amount of the recording medium-dissolving agent may be appropriately determined, but is preferably about 0.1 to 30% by mass and more preferably about 1 to 20% by mass.

The ink composition for ink jet recording according to an aspect of the invention preferably contains a wetting agent, for example, glycerin or its derivative, such as 3-(2-hydroxyethoxy)-1,2-propanediol (CAS No. 14641-24-8) and 3-(2-hydroxypropoxy)-1,2-propanediol. Glycerin and its derivative have functions of preventing ink, for example, in an ink jet nozzle from drying and solidifying and are therefore preferred from the viewpoint of improving the recovery property from clogging. In an aspect of the invention, the ink composition can contain the wetting agent in an amount of from 0.1 to 8% by mass.

The clear ink composition according to an aspect of the invention can further contain a nozzle clogging-preventing agent, an antiseptic, an antioxidant, an electroconductivity adjuster, a pH adjuster, a viscosity modifier, a surface tension adjuster, or an oxygen absorber, for example.

Examples of the antiseptic/anti-fungal agents include sodium benzoate, sodium pentachlorophenol, sodium 2-pyridinethiol-1-oxide, sodium sorbate, sodium dehydroacetate, and 1,2-dibenzine thiazolin-3-one (Proxel CRL, Proxel BND, Proxel GXL, Proxel XL-2, and Proxel TN, available from ICI Co., Ltd.).

Furthermore, examples of the pH adjuster, the solubilization aid, and the antioxidant include amines, such as diethanolamine, triethanolamine, propanolamine, and morpholine and modified products thereof; inorganic salts, such as potassium hydroxide, sodium hydroxide, and lithium hydroxide; ammonium hydroxide; quaternary ammonium hydroxide (for example, tetramethyl ammonium); carbonates, such as potassium carbonate, sodium carbonate, and lithium carbonate; phosphates; ureas, such as N-methyl-2-pyrrolidone, urea, thiourea, and tetramethylurea; allophanates, such as allophanate and methyl allophanate; biurets, such as biuret, dimethyl biuret, and tetramethyl biuret; and L-ascorbic acid and salts thereof.

In addition, the clear ink composition according to an aspect of the invention may contain an antioxidant and an ultraviolet absorber, and examples thereof include Tinuvin 328, 900, 1130, 384, 292, 123, 144, 622, 770, and 292, Irgacor 252 and 153, and Irganox 1010, 1076, 1035, and MD 1024 (products of Chiba Specialty Chemicals Inc.) and oxides of lanthanide.

The clear ink composition according to an aspect of the invention can be produced by dispersing and mixing each component described above by a proper method. Preferably, first, a uniform pigment dispersion is prepared by mixing a pigment, a polymer dispersant, and water with a proper disperser (for example, a ball mill, a sand mill, an attritor, a roll mill, an agitator mill, a Henschel mixer, a colloid mill, an ultrasonic homogenizer, a jet mill, or an angmill). Then, added to the resulting pigment dispersion are a separately prepared resin (resin emulsion), water, a water-soluble organic solvent, a saccharide, a pH adjuster, an antiseptic, an anti-fungal agent, and other components. These components are sufficiently dissolved to prepare an ink solution. After sufficient stirring, coarse particles and foreign materials, which cause clogging, are removed by filtration to obtain a target ink composition. The filtration may be preferably performed using a glass fiber filter. The glass fiber is preferably resin-impregnated glass fiber from the viewpoint of an electrostatic adsorption function. The pore size of the glass fiber filter is preferably 1 to 40 μm and more preferably 1 to 10 μm from the viewpoints of productivity and adsorptive removal of, for example, an electric charge-free resin. By sufficiently removing adsorption of an electric charge-free resin, etc., the discharge stability can be improved. An example of the filter is Ultipor GF Plus, a product of Nihon Pall Ltd.

### Ink Jet Recording Method

In an ink jet recording method according to an aspect of the invention, printing can be performed by using at least the clear ink composition described above and an ink composition containing a colorant described below, as ink compositions, and discharging droplets of the ink compositions and letting the droplets adhere to a recording medium. The clear ink composition according to an aspect of the invention and the ink composition containing a colorant described below are preferably used in ink jet recording.

The order of adhering of the ink droplets to a recording medium is not particularly limited, but it is preferable to let droplets of the clear ink composition to adhere to a recording medium first and then to let droplets of the ink composition containing a colorant for ink jet recording adhere to the recording medium. In addition, it is preferable to let the clear ink adhere to a recording medium in such a manner that the coverage proportion of the clear ink in the region where recording by the ink composition containing a colorant is performed (hereinafter may be simply referred to as “coverage proportion by the clear ink”) is 50 to 200% and more preferably 60 to 160%. Within this range, a high-quality image can be obtained. In the specification, the term “coverage proportion by the clear ink” refers to the value obtained by dividing the product of the average dot area of the clear ink adhering to the region where recording by the ink composition containing a colorant is performed and the number of dots per 1 inch² of the clear ink adhering to the region where recording by the ink composition containing a colorant is performed by the unit area of the region where recording by the ink composition containing a colorant is performed (i.e., 1 inch²), and is the value calculated by the following expression:

Coverage proportion(%)=[(average dot area in the region where recording by the ink composition containing a colorant is performed)×(number of dots per 1 inch²)]/(unit area of the region where recording by the ink composition containing a colorant is performed)×100

(in the expression, the term “average dot area” means the area of a circle calculated by using an average dot diameter described below as the diameter). Furthermore, it is preferable that the clear ink uniformly adhere to the region where recording by the ink composition containing a colorant is performed.

In the recording method according to an aspect of the invention, it is preferable to use synthetic paper or printing paper (OKT+: manufactured by Oji Paper Co., Ltd.) as a recording medium. Especially, a high-quality image being free from bleeding and beading can be realized on art paper, paper for high image quality used in print on demand (POD), and exclusive paper for laser printers, in particular, even in low-resolution printing. Examples of the paper for high image quality used in POD include Ricoh business coat gloss 100 (manufactured by Ricoh Company, Ltd.). Examples of the exclusive paper for laser printers include LPCCTA4 (manufactured by Seiko Epson Corp.). Examples of water resistant paper include Kareka (manufactured by Mitsubishi Kagaku Media Co., Ltd.) and LaserPeach (manufactured by Nisshinbo Postal Chemical Co., Ltd.).

### Ink Set

The ink set according to an aspect of the invention includes at least the above-described clear ink composition and an ink composition containing a colorant described below, and the ink composition containing a colorant may include at least one selected from the group consisting of yellow ink compositions, magenta ink compositions, cyan ink compositions, and black ink compositions. According to an aspect of a preferred ink set of the invention, it is possible to adjust the initial viscosity and adjust the change in viscosity after storage, and it is possible to stabilize the mass of each ink to be discharged over a long period of time. Accordingly, an inorganic pigment can be contained in at least one selected from the group consisting of yellow ink compositions, magenta ink compositions, cyan ink compositions, and black ink compositions.

### Ink Composition Containing a Colorant

In the ink composition containing a colorant and being used together with the clear ink composition according to an aspect of the invention, any of a dye and a pigment can be used as a colorant, but the pigment is preferred from the viewpoints of light resistance and water resistance. Furthermore, the colorant preferably contains a pigment and a dispersant that can disperse the pigment in ink and is preferably an anionic dispersion. The dispersant is described below.

Examples of the pigment include inorganic pigments and organic pigments, and these may be used alone or as a mixture of two or more thereof. Examples of the organic pigment include azo pigments (including, for example, azolakes, insoluble azo pigments, condensed azo pigments, and chelate azo pigments), polycyclic pigments (for example, phthalocyanine pigments, perylene pigments, perynone pigments, anthraquinone pigments, quinacridone pigments, dioxadine pigments, thioindigo pigments, isoindolinone pigments, and quinophthalone pigments), dye chelates (for example, basic dye-type chelates and acid dye-type chelates), nitro pigments, nitroso pigments, and aniline black, and also include carbon black produced by a known method, such as a contact method, a furnace method, or a thermal method.

Specific examples of the pigment can be exemplified according to the type (color) of an ink composition to be prepared. Examples of the pigment for a yellow ink composition include C.I. Pigment Yellow 1, 2, 3, 12, 14, 16, 17, 73, 74, 75, 83, 93, 95, 97, 98, 109, 110, 114, 128, 129, 138, 139, 147, 150, 151, 154, 155, 180, and 185, and one or more thereof are used. In particular, one or more selected from the group consisting of C.I. Pigment Yellow 74, 110, 128, and 129 are preferably used. Examples of the pigment for a magenta ink composition include C.I. Pigment Red 5, 7, 12, 48(Ca), 48(Mn), 57(Ca), 57:1, 112, 122, 123, 168, 184, 202, and 209 and C.I. Pigment Violet 19, and one or more thereof are used. In particular, one or more selected from the group consisting of C.I. Pigment Red 122, 202, and 209 and C.I. Pigment Violet 19 are preferably used, and also a solid solution thereof may be used. Examples of the pigment for a cyan ink composition include C.I. Pigment Blue 1, 2, 3, 15:2, 15:3, 15:4, 15:34, 16, 22, and 60 and C.I. Vat Blue 4 and 60, and one or more thereof are used. In particular, C.I. Pigment Blue 15:3 and/or 15:4 is preferably used. Especially, C.I. Pigment Blue 15:3 is preferably used.

Examples of the pigment for a black ink composition include inorganic pigments, e.g., carbons such as lamp black (C.I. Pigment Black 6), acetylene black, furnace black (C.I. Pigment Black 7), channel black (C.I. Pigment Black 7), and carbon black (C.I. Pigment Black 7), and iron oxide pigments; and organic pigments such as aniline black (C.I. Pigment Black 1). In an aspect of the invention, carbon black is preferably used. Specific examples of the carbon black include #2650, #2600, #2300, #2200, #1000, #980, #970, #966, #960, #950, #900, #850, MCF-88, #55, #52, #47, #45, #45L, #44, #33, #32, and #30 (these are products of Mitsubishi Chemical Corp.), Special Black 4 and 550 and Printex 95, 90, 85, 80, 75, 45, and 40 (these are products of Degussa AG), Regal 660, Rmogul L, and monarch 1400, 1300, 1100, 800, and 900 (these are products of Cabot Corp.), and Raven 7000, 5750, 5250, 3500, 2500 ULTRA, 2000, 1500, 1255, 1200, 1190 ULTRA, 1170, 1100 ULTRA, and Raven 5000 UIII (these are products of Columbian Chemicals Co.).

The concentration of the pigment in the ink composition containing a colorant, which is used together with the clear ink composition according to the invention, may be adjusted to an appropriate pigment concentration (content) when the ink composition is prepared and, therefore, is not particularly limited. However, in the invention, the solid content concentration of the pigment is preferably 1.0 to 10.0% by mass and, from the viewpoint of granularity, preferably 1.0 to 3.0% by mass. The ink composition containing a colorant, which is used together with the clear ink composition according to the invention, is not particularly limited, but, for example, when recording is performed on a recording medium having a low water-absorbing property, such as printing paper, a combination of the poor water-soluble alkanediol, the crystalline carbohydrate, and the poly(oxyalkylene glycol) is more preferred.

### Dispersant

The ink composition containing a colorant, which is used together with the clear ink composition according to the invention, preferably contains at least one resin selected from the group consisting of styrene-acrylic acid-based copolymer resins, oxyethyl acrylate-based resins, urethane-based resins, and fluorene-based resins, more preferably at least one selected from the group consisting of oxyethyl acrylate-based resins and fluorene-based resins. These copolymer resins adsorb to pigments to improve the dispersibility of the pigments.

Specific examples of the hydrophobic monomer of the copolymer resin include methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, sec-butyl acrylate, sec-butyl methacrylate, tert-butyl acrylate, tert-butyl methacrylate, n-hexyl acrylate, n-hexyl methacrylate, n-octyl acrylate, n-octyl methacrylate, iso-octyl acrylate, iso-octyl methacrylate, 2-ethyl hexyl acrylate, 2-ethyl hexyl methacrylate, decyl acrylate, decyl methacrylate, lauryl acrylate, lauryl methacrylate, stearyl acrylate, stearyl methacrylate, 2-hydroxyethyl acrylate, 2-hydroxyethyl methacrylate, 2-hydroxypropyl acrylate, 2-hydroxypropyl methacrylate, 2-dimethylaminoethyl acrylate, 2-dimethylaminoethyl methacrylate, 2-diethylaminoethyl acrylate, 2-diethylaminoethyl methacrylate, glycidyl acrylate, glycidyl methacrylate, allyl acrylate, allyl methacrylate, cyclohexyl acrylate, cyclohexyl methacrylate, phenyl acrylate, phenyl methacrylate, nonylphenyl acrylate, nonylphenyl methacrylate, benzyl acrylate, benzyl methacrylate, dicyclopentenyl acrylate, dicyclopentenyl methacrylate, bornyl acrylate, bornyl methacrylate, 1,3-butanediol diacrylate, 1,3-butanediol dimethacrylate, 1,4-butanediol diacrylate, 1,4-butanediol dimethacrylate, ethylene glycol diacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, polyethylene glycol diacrylate, polyethylene glycol dimethacrylate, neopentyl glycol diacrylate, 1,6-hexanediol diacrylate, 1,6-hexanediol dimethacrylate, dipropylene glycol diacrylate, dipropylene glycol dimethacrylate, trimethylol propane triacrylate, trimethylol propane trimethacrylate, glycerol acrylate, glycerol methacrylate, styrene, methylstyrene, vinyl toluene, and hydroxyethylated orthophenylphenol acrylate. These may be used alone or as a mixture of two or more thereof.

Specific examples of the hydrophilic monomer include acrylic acid, methacrylic acid, maleic acid, and itaconic acid.

From the viewpoints of achieving good balance among gloss of a color image, prevention of bronzing, and storage stability of the ink composition and also of forming a color image with more excellent gloss, the copolymer resin of the above-mentioned hydrophobic monomer and hydrophilic monomer is preferably at least any of a styrene-(meth)acrylic acid copolymer resin, a styrene-methylstyrene-(meth)acrylic acid copolymer resin, a styrene-maleic acid copolymer resin, a (meth)acrylic acid-(meth)acrylic acid ester copolymer resin, a styrene-(meth)acrylic acid-(meth)acrylic acid ester copolymer resin, and a hydroxyethylated orthophenylphenol acrylic acid ester-(meth)acrylic acid copolymer resin.

The copolymer resin may be a resin (styrene-acrylic acid resin) containing a polymer prepared by a reaction of styrene and acrylic acid or acrylic acid ester. Alternatively, the copolymer resin may be an acrylic acid-based water-soluble resin or a salt thereof, such as a sodium, potassium, ammonium, triethanolamine, triisopropanolamine, triethylamine, or diethanolamine salt.

The acid value of the copolymer resin is preferably 50 to 320 and more preferably 100 to 250 from the viewpoints of achieving good balance among gloss of a color image, prevention of bronzing, and storage stability of the ink composition and also of forming a color image with more excellent gloss.

The weight-average molecular weight (Mw) of the copolymer resin is preferably 2000 to 30000 and more preferably 2000 to 20000 from the viewpoints of achieving good balance among gloss of a color image, prevention of bronzing, and storage stability of the ink composition and also of forming a color image with more excellent gloss.

The glass transition temperature (Tg: measured in accordance with JIS K6900) of the copolymer resin is preferably 30° C. or more and more preferably 50 to 130° C. from the viewpoints of achieving good balance among gloss of a color image, prevention of bronzing, and storage stability of the ink composition and also of forming a color image with more excellent gloss.

The copolymer resin is adsorbed to the pigment or is free in a pigment dispersion and preferably has a maximum particle diameter of 0.3 μm or less and more preferably has an average particle diameter of 0.2 μm or less (more preferably 0.1 μm or less), from the viewpoints of achieving good balance among gloss of a color image, prevention of bronzing, and storage stability of the ink composition and also of forming a color image with more excellent gloss. Note that the average particle diameter is the average value of dispersion diameters (50% cumulative diameter) of particles actually formed by the pigment in the dispersion and can be measured with, for example, a Microtrac UPA (Microtrac Inc.).

The content of the copolymer resin is preferably 20 to 50 parts by mass and more preferably 20 to 40 parts by mass based on 100 parts by mass of the pigment, from the viewpoints of achieving good balance among gloss of a color image, prevention of bronzing, and storage stability of the ink composition and also of forming a color image with more excellent gloss.

In an aspect of the invention, an oxyethyl acrylate-based resin also can be used as the copolymer resin. The use of such a resin provides a reduction in the initial viscosity of ink, excellent storage stability at high temperature, and an excellent recovery property from clogging and is therefore more preferred.

The oxyethyl acrylate-based resin is not particularly limited as long as it has an oxyethyl acrylate skeleton, but is preferably a compound represented by Formula (III) shown below. Examples of the compound represented by Formula (III) include resins containing, in molar proportions of monomers, 45 to 55% of ortho-hydroxyethylated phenylphenol acrylate having CAS No. 72009-86-0, 20 to 300 of acrylic acid having CAS No. 79-10-7, and 20 to 30% of methacrylic acid having CAS No. 79-41-4. These may be used alone or as a mixture of two or more thereof. Furthermore, the component proportions of the monomers are not particularly limited, but are preferably 70 to 85% by mass of the ortho-hydroxyethylated phenylphenol acrylate having CAS No. 72009-86-0, 5 to 15% by mass of acrylic acid having CAS No. 79-10-7, and 10 to 20% by mass of methacrylic acid having CAS No. 79-41-4.

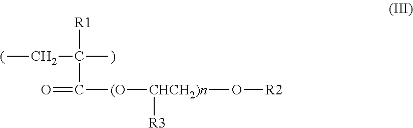

(in Formula (III), R1 and/or R3 are a hydrogen atom or a methyl group; R2 is an alkyl group or an aryl group; and n is an integer of 1 or more).

Preferred examples of the compound represented by Formula (III) include nonylphenoxypolyethylene glycol acrylate and polypropylene glycol #700 acrylate.

The content of the oxyethyl acrylate-based resin is preferably 10 to 40 parts by mass and more preferably 15 to 25 parts by mass based on 100 parts by mass of the pigment, from the viewpoints of achieving good balance between the initial viscosity of the ink composition and storage stability of the ink composition and also of inhibiting aggregation spots and forming a color image having an excellent burying property.

The total of the component proportions of resins derived from monomers having hydroxyl groups selected from the group consisting of acrylic acids and methacrylic acids in the oxyethyl acrylate-based resin is preferably 30 to 70% and more preferably 40 to 60%, from the viewpoints of achieving good balance between the initial viscosity of the ink composition and the storage stability of the ink composition and also of the recovery property from clogging.

The number-average molecular weight (Mn) of the oxyethyl acrylate-based resin before cross-linking is preferably 4000 to 9000 and more preferably 5000 to 8000, from the viewpoints of achieving good balance between the initial viscosity of the ink composition and the storage stability of the ink composition. The Mn is measured by, for example, gel permeation chromatography (GPC).

The oxyethyl acrylate-based resin is adsorbed to the pigment or is free in a pigment dispersion, and the copolymer resin preferably has a maximum particle diameter of 0.3 μm or less and more preferably has an average particle diameter of 0.2 μm or less (more preferably 0.1 μm or less), from the viewpoints of achieving good balance among gloss of a color image, prevention of bronzing, and storage stability of the ink composition and also of forming a color image with more excellent gloss. Note that the average particle diameter is the average value of dispersion diameters (50% cumulative diameter) of particles actually formed by the pigment in the dispersion and can be measured with, for example, a Microtrac UPA (Microtrac Inc.).

The content of the oxyethyl acrylate-based resin is preferably 20 to 50 parts by mass and more preferably 20 to 40 parts by mass based on 100 parts by mass of the pigment, from the viewpoints of achieving good balance among gloss of a color image, prevention of bronzing, and storage stability of the ink composition and also of forming a color image with more excellent gloss.

Furthermore, in the ink composition containing a colorant, which is used together with the clear ink composition according to the invention, good balance among gloss of a color image, prevention of bronzing, and storage stability of the ink composition can be achieved and a color image having more excellent gloss can be formed by using a urethane-based resin as a fixative pigment dispersant. The urethane-based resin is a resin containing a polymer obtained by a reaction of a diisocyanate compound and a diol compound and is, in an aspect of the invention, preferably a resin that has a urethane bond and/or an amide bond and includes an acid group.

Examples of the diisocyanate compound include araliphatic diisocyanate compounds such as hexamethylene diisocyanate and 2,2,4-trimethyl hexamethylene diisocyanate; aromatic diisocyanate compounds such as toluylene diisocyanate and phenylmethane diisocyanate; and modified derivatives thereof.

Examples of the diol compound include polyethers such as polyethylene glycol and polypropylene glycol; polyesters such as polyethylene adipate and polybutylene adipate; and polycarbonates.

The acid value of the urethane-based resin is preferably 10 to 300 and more preferably 20 to 100 from the viewpoints of achieving good balance among gloss of a color image, prevention of bronzing, and storage stability of the ink composition and also of forming a color image with more excellent gloss. Note that the acid value is the number of mg of KOH required to neutralize 1 g of the resin.

The weight-average molecular weight (Mw) of the urethane resin before cross-linking is preferably 100 to 200000 and more preferably 1000 to 50000 from the viewpoints of achieving good balance among gloss of a color image, prevention of bronzing, and storage stability of the ink composition and also of forming a color image with more excellent gloss. The Mw is measured by, for example, gel permeation chromatography (GPC).

The glass transition temperature (Tg: measured in accordance with JIS K6900) of the urethane resin is preferably −50 to 200° C. and more preferably −50 to 100° C. from the viewpoints of achieving good balance among gloss of a color image, prevention of bronzing, and storage stability of the ink composition and also of forming a color image with more excellent gloss.

The urethane-based resin preferably has a carboxyl group.

The content of the urethane-based resin is preferably 20 to 50 parts by mass and more preferably 20 to 40 parts by mass based on 100 parts by mass of the pigment from the viewpoints of achieving good balance among gloss of a color image, prevention of bronzing, and storage stability of the ink composition and also of forming a color image with more excellent gloss.

Furthermore, in an aspect of the invention, a fluorene-based resin can be used as a fixative pigment dispersant. The use such a resin causes a reduction in the initial viscosity of ink and provides excellent storage stability at high temperature and an excellent fixing property to printing paper, and is therefore preferred.

In addition, the fluorene-based resin is not particularly limited as long as it has a fluorene skeleton, and, for example, can be obtained by copolymerizing the following monomer units:

cyclohexane, 5-isocyanate-1-(isocyanate methyl)-1,3,3-trimethyl- (CAS No. 4098-71-9); ethanol, 2,2′-[9H-fluoren-9-ylidenebis(4,1-phenyleneoxy)]bis- (CAS No. 117344-32-8); propionic acid, 3-hydroxy-2-(hydroxymethyl)-2-methyl- (CAS No. 4767-03-7); and ethanamine, N,N-diethyl- (CAS No. 121-44-8).

The component proportions of the monomers in the fluorene resin are not particularly limited as long as the resin has a fluorene skeleton, but are preferably 35 to 45% by mass of cyclohexane, 5-isocyanate-1-(isocyanate methyl)-1,3,3-trimethyl- (CAS No. 4098-71-9), 40 to 60% by mass of ethanol, 2,2′-[9H-fluoren-9-ylidenebis(4,1-phenyleneoxy)]bis- (CAS No. 117344-32-8), 5 to 15% by mass of propionic acid, 3-hydroxy-2-(hydroxymethyl)-2-methyl- (CAS No. 4767-03-7), and 5 to 15% by mass of ethanamine, N,N-diethyl- (CAS No. 121-44-8).

The number-average molecular weight (Mn) of the fluorene-based resin before cross-linking is preferably 2000 to 5000 and more preferably 3000 to 4000 from the viewpoints of achieving good balance between the initial viscosity of the ink composition and the storage stability of the ink composition. The Mn is measured by, for example, gel permeation chromatography (GPC).

The fluorene-based resin is adsorbed to the pigment or is free in a pigment dispersion, and the copolymer resin preferably has a maximum particle diameter of 0.3 μm or less and more preferably has an average particle diameter of 0.2 μm or less (further preferably 0.1 μm or less), from the viewpoints of achieving good balance among gloss of a color image, prevention of bronzing, and storage stability of the ink composition and also of forming a color image with more excellent gloss. Note that the average particle diameter is the average value of dispersion diameters (50% cumulative diameter) of particles actually formed by the pigment in the dispersion and can be measured with, for example, a Microtrac UPA (Microtrac Inc.).

The content of the fluorene-based resin is preferably 20 to 50 parts by mass and more preferably 20 to 40 parts by mass based on 100 parts by mass of the pigment from the viewpoints of achieving good balance among a color image-fixing property, prevention of bronzing, and storage stability of the ink composition and also of forming a color image with a more excellent fixing property.

The mass ratio of the copolymer resin to the fixative pigment dispersant (the former/the latter) is preferably 1/2 to 2/1 and, from the viewpoints of achieving good balance among gloss of a color image, prevention of bronzing, and storage stability of the ink composition and also of forming a color image with more excellent gloss, more preferably 1/1.5 to 1.5/1.

The mass ratio of the solid content of the pigment to the total solid content of the copolymer resin and the fixative pigment dispersant (the former/the latter) is preferably 100/40 to 100/100 from the viewpoints of achieving good balance among gloss of a color image, prevention of bronzing, and storage stability of the ink composition and also of forming a color image with more excellent gloss.

Furthermore, a surfactant may be used as the dispersant. Examples of the surfactant include anionic surfactants, such as fatty acid salts, higher alkyl dicarboxylates, higher alcohol sulfates, higher alkyl sulfonates, condensates of higher fatty acids and amino acids, sulfosuccinates, naphthenates, liquid fatty oil sulfates, and alkylallyl sulfonates; cationic surfactants, such as fatty acid amine salts, quaternary ammonium salts, sulfonium salts, and phosphonium; and nonionic surfactants, such as polyoxyethylene alkyl ethers, polyoxyethylene alkyl esters, sorbitan alkyl esters, and polyoxyethylene sorbitan alkyl esters. It is needless to say that these surfactants also function as surfactants when they are added to ink compositions.

### EXAMPLES

The invention will be more specifically described with reference to examples below, but is not limited to these examples.

Hereinafter, allylamine is abbreviated as “AA”, N,N-dimethylallylamine is abbreviated as “DMAA”, and N,N-diallylmethylamine is abbreviated as “DANA”, and“%” means “% by mass”, unless otherwise specifically designated.

### Measurement of Weight-Average Molecular Weight of Polymer

The weight-average molecular weight (Mw) of a polymer was measured by gel permeation chromatography (GPC) using a Hitachi L-6000 high-performance liquid chromatograph. Hitachi L-6000 was used as the eluent channel pump, a Shodex RI SE-61 differential refractive index detector was used as the detector, and Asahipak aqueous gel filtration GS-220HQ (exclusion limit molecular weight: 3000) and GS-620HQ (exclusion limit molecular weight: 2000000) connected to each other were used as the column. The concentration of a sample was adjusted with an eluent to 0.5 g/100 ml, and 20 μL of the sample was used. As the eluent, a 0.4 mol/L aqueous solution of sodium chloride was used. The measurement was performed at a column temperature of 30° C. at a flow rate of 1.0 mL/min. A calibration curve was drawn using polyethylene glycols having molecular weights of 106, 194, 440, 600, 1470, 4100, 7100, 10300, 12600, and 23000 as standard samples, and Mw of a polymer was determined based on the calibration curve.

### Production of Modified Polyallylamine

### Production Example 1

### Production of Modified PAA-1

### Copolymer of DAMA and AA (5/5)

A 2000-mL four-neck separable flask equipped with a stirrer, a Dimroth reflux device, and a thermometer was charged with 159.10 g of a 58.80% aqueous solution of monoallylamine hydrochloride, 212.20 g of a 69.58% aqueous solution of N,N-diallylmethylamine hydrochloride, and 834.70 g of distilled water. The aqueous solution of the monomers was warmed to 65° C., and 54.24 g of 2,2′-azobis(2-amidinopropane)dihydrochloride was added thereto as a radical initiator, and polymerization was allowed to proceed for 48 hours.

After completion of the polymerization, 193.30 g of a 50% aqueous solution of sodium hydroxide was dropwise added thereto under ice-cooling to neutralize hydrochloric acid. After completion of the neutralization, unreacted monomers were evaporated at 50° C. under reduced pressure (10.6 kPa).

The thus-obtained solution was subjected to electrodialysis for desalting to obtain 1055.43 g of a 14.35% aqueous solution of free-type copolymer of N,N-diallylmethylamine and allylamine (copolymerization ratio of 5:5).

A copolymer hydrochloride was prepared by converting a part of the aqueous solution of the copolymer into a hydrochloride salt and reprecipitating the salt from an isopropanol solvent. The results of the elemental analysis were C=50.02, H=9.01, and N=11.32 and were in agreement with calculated values C=49.80, H=9.19, and N=11.64.

### Production Example 2a

### Production of Modified PAA-2a

### Copolymer of DAMA and Carbamoylated AA (5/5)

A 1000-mL four-neck separable flask equipped with a stirrer, a Dimroth reflux device, and a thermometer was charged with 586.35 g of a 14.35% aqueous solution of the free-type copolymer of N,N-diallylmethylamine and allylamine obtained in Production Example 1, and 104.17 g of 35% hydrochloric acid was dropwise added thereto under ice-cooling, followed by warming to 50° C. Then, 455.07 g of a 7.5% aqueous solution of sodium cyanate was dropwise added thereto, and a reaction was allowed to proceed for 24 hours.

After completion of the reaction, 42.00 g of 50% sodium hydroxide was dropwise added thereto under ice-cooling to neutralize unreacted hydrochloric acid.

The thus-obtained solution was subjected to electrodialysis for desalting to obtain 907.00 g (yield: 97%) of a 11.30% aqueous solution of free-type copolymer of N,N-diallylmethylamine and carbamoylated allylamine (copolymerization ratio of 5:5). The weight-average molecular weight of this copolymer was 1800.

The copolymer was concentrated to obtain a solid, and solubilities of the copolymer in various solvents were investigated at a concentration of 10%. The results were that the polymer was insoluble in acetone and acetonitrile, but was soluble in methanol, ethanol, isopropanol, DMSO, and DMF. The results show that the copolymer of the invention is also soluble in organic solvents, compared with an allylamine polymer.

A copolymer hydrochloride was prepared by converting a part of the aqueous solution of the copolymer into a hydrochloride salt and reprecipitating the salt from an acetone solvent. This result shows that the modified polyallylamine of the invention can become a cationic polymer.

The results of the elemental analysis were C=53.58, H=8.92, and N=16.64 and were in agreement with calculated values C=53.32, H=8.95, and N=16.9. The carbamoylation mole fraction calculated by neutralization titration of the copolymer hydrochloride was 46.76%, which was approximately equivalent to the result of the elemental analysis.

### Production Example 2b

### Production of Modified PAA-2b

### Copolymer of DAMA and Carbamoylated AA (3/7)

As in Production Example 1, 889.95 g of a 14.50% aqueous solution of free-type copolymer of N,N-diallylmethylamine and allylamine (copolymerization ratio of 3:7) was prepared by using 127.32 g of a 69.58% aqueous solution of N,N-diallylmethylamine hydrochloride, 222.75 g of 58.80% monoallylamine, and 747.78 g of distilled water.

As in Production Example 2a, 853.10 g (yield: 95%) of a 11.52% aqueous solution of free-type copolymer of N,N-diallylmethylamine and carbamoylated allylamine (copolymerization ratio of 3:7) was prepared by using 505.67 g of the aqueous solution of the copolymer above, 637.10 g of an aqueous solution of sodium cyanate, and 25.20 g of an aqueous solution of sodium hydroxide. The weight-average molecular weight of this copolymer was 1500.

### Production Example 2c

### Production of Modified PAA-2c

### Copolymer of DAMA and Carbamoylated AA (7/3)

As in Production Example 1, 1218.26 g of a 14.81% aqueous solution of free-type copolymer of N,N-diallylmethylamine and allylamine (copolymerization ratio of 7:3) was prepared by using 297.08 g of a 69.58% aqueous solution of N,N-diallylmethylamine hydrochloride, 95.46 g of 58.80% monoallylamine, and 921.66 g of distilled water.

As in Production Example 2a, 940.95 g (yield: 97%) of a 11.12% aqueous solution of free-type copolymer of N,N-diallylmethylamine and carbamoylated allylamine (copolymerization ratio of 7:3) was prepared by using 641.18 g of the aqueous solution of the copolymer above, 273.04 g of an aqueous solution of sodium cyanate, and 58.80 g of an aqueous solution of sodium hydroxide. The weight-average molecular weight of this copolymer was 2100.

### Production Example 3

### Production of Modified PAA-3

### Copolymer of DAMA and Methoxycarbonylated AA (5/5)

A 1000-mL four-neck separable flask equipped with a stirrer, a Dimroth reflux device, and a thermometer was charged with 586.35 g of a 14.35% aqueous solution of the free-type copolymer of N,N-diallylmethylamine and allylamine obtained in Production Example 1. The solution was warmed to 50° C., and 47.77 g of dimethyl carbonate having a purity of 99% was dropwise added thereto, and a reaction was allowed to proceed for 24 hours.

After completion of the reaction, by-produced methanol was removed at 50° C. under reduced pressure (80 mmHg) to obtain 494.19 g (yield: 98%) of a 22.44% aqueous solution of free-type copolymer of N,N-diallylmethylamine and methoxycarbonylated allylamine (copolymerization ratio of 5:5). The weight-average molecular weight of this copolymer was 1900.

A copolymer hydrochloride was prepared by converting a part of the aqueous solution of the copolymer into a hydrochloride salt and reprecipitating the salt from an isopropanol solvent. The results of the elemental analysis were C=54.69, H=8.62, and N=10.37 and were in agreement with calculated values C=54.85, H=8.82, and N=10.66. The methoxycarbonylation mole fraction calculated by neutralization titration of the copolymer hydrochloride was 49.88%, which was approximately equivalent to the result of the elemental analysis.

### Production Example 4

### Production of Modified PAA-4

### Copolymer of DAMA and Acetylated AA (5/5)

A 1000-mL four-neck separable flask equipped with a stirrer, a Dimroth reflux device, and a thermometer was charged with 586.35 g of a 14.35% aqueous solution of the free-type copolymer of N,N-diallylmethylamine and allylamine obtained in Production Example 1. Under ice cooling, acetic anhydride having a purity of 98% was dropwise added thereto by a half of the molar quantity of the allylamine, and neutralization was performed with 42.00 g of 50% sodium hydroxide corresponding to the molar quantity of the by-produced acetic acid. This procedure was repeated to add the whole quantity (54.69 g) of the acetic anhydride, and the reaction was allowed to proceed for 24 hours.

The thus-obtained solution was subjected to electrodialysis for desalting to obtain 695.50 g (yield: 100%) of a 15.12% aqueous solution of free-type copolymer of N,N-diallylmethylamine and acetylated allylamine (copolymerization ratio of 5:5). The weight-average molecular weight of this copolymer was 1900.

A copolymer hydrochloride was prepared by converting a part of the aqueous solution of the copolymer into a hydrochloride salt and reprecipitating the salt from an isopropanol solvent. The results of the elemental analysis were C=58.31, H=9.16, and N=11.07 and were in agreement with calculated values C=58.41, H=9.40, and N=11.35. The acetylation mole fraction calculated by neutralization titration of the copolymer hydrochloride was 50.06%, which was approximately equivalent to the result of the elemental analysis.

### Production Example 5

### Production of Modified PAA-5

### Copolymer of DAMA and Monocarbamoylethylated AA (5/5)

A 1000-mL four-neck separable flask equipped with a stirrer, a Dimroth reflux device, and a thermometer was charged with 586.35 g of a 14.35% aqueous solution of the free-type copolymer of N,N-diallylmethylamine and allylamine obtained in Production Example 1. The solution was warmed to 50° C., and 74.63 g of 50% acrylamide was dropwise added thereto, and a reaction was allowed to proceed for 24 hours. Thus, 631.93 g (yield: 98%) of a 18.56% aqueous solution of free-type copolymer of N,N-diallylmethylamine and monocarbamoylethylated allylamine (copolymerization ratio of 5:5) was obtained. The weight-average molecular weight of this copolymer was 1800.

A copolymer hydrochloride was prepared by converting a part of the aqueous solution of the copolymer into a hydrochloride salt and reprecipitating the salt from an isopropanol solvent. The results of the elemental analysis were C=56.48, H=8.99, and N=15.38 and were in agreement with calculated values C=56.61, H=9.50, and N=15.24. The monopropylamidation mole fraction calculated by neutralization titration of the copolymer hydrochloride was 49.03%, which was approximately equivalent to the result of the elemental analysis.

### Production Example 6

### Production of Modified PAA-6

### Copolymer of DAMA and Dicarbamoylethylated AA (5/5)

As in Production Example 5, 647.03 g (yield: 97%) of a 23.27% aqueous solution of free-type copolymer of N,N-diallylmethylamine and dicarbamoylethylated allylamine (copolymerization ratio of 5:5) was prepared by using 149.27 g of acrylamide. The weight-average molecular weight of this copolymer was 1800.

A copolymer hydrochloride was prepared by converting a part of the aqueous solution of the copolymer into a hydrochloride salt and reprecipitating the salt from an isopropanol solvent. The results of the elemental analysis were C=55.18, H=8.75, and N=15.81 and were in agreement with calculated values C=55.40, H=9.01, and N=16.15. The dipropylamidation mole fraction calculated by neutralization titration of the copolymer hydrochloride was 48.71%, which was approximately equivalent to the result of the elemental analysis.

### Production Example 7

### Production of Modified PAA-7

### Copolymer of DAMA and Monoethoxy-2-Hydroxypropylated AA (5/5)

A 1000-mL four-neck separable flask equipped with a stirrer, a Dimroth reflux device, and a thermometer was charged with 586.35 g of a 14.35% aqueous solution of the free-type copolymer of N,N-diallylmethylamine and allylamine obtained in Production Example 1. The solution was warmed to 50° C., and 53.62 g of ethylglycidyl ether with a purity 100% was dropwise added thereto, and a reaction was allowed to proceed for 24 hours. Thus, 614.87 g (yield: 100%) of a 21.99% aqueous solution of free-type copolymer of N,N-diallylmethylamine and monoethoxy-2-hydroxypropylated allylamine (copolymerization ratio of 5:5) was obtained. The weight-average molecular weight of this copolymer was 1800.

A copolymer hydrochloride was prepared by converting a part of the aqueous solution of the copolymer into a hydrochloride salt and reprecipitating the salt from an isopropanol solvent. The results of the elemental analysis were C=58.50, H=9.99, and N=9.08 and were in agreement with calculated values C=58.71, H=10.18, and N=9.13. The monoethoxy-2-hydroxypropylation mole fraction calculated by neutralization titration of the copolymer hydrochloride was 50.12%, which was approximately equivalent to the result of the elemental analysis.

### Production Example 8

### Production of Modified PAA-8

### Copolymer of DAMA and Diethoxy-2-Hydroxypropylated AA (5/5)

As in Production Example 7, 644.36 g (yield: 99%) of a 28.62% aqueous solution of free-type copolymer of N,N-diallylmethylamine and diethoxy-2-hydroxypropylated allylamine (copolymerization ratio of 5:5) was prepared by using 107.24 g of ethyleneglycidyl ether. The weight-average molecular weight of this copolymer was 1800.

A copolymer hydrochloride was prepared by converting a part of the aqueous solution of the copolymer into a hydrochloride salt and reprecipitating the salt from an isopropanol solvent. The results of the elemental analysis were C=58.56, H=9.98, and N=6.73 and were in agreement with calculated values C=58.73, H=10.10, and N=6.85. The diethoxy-2-hydroxypropylation mole fraction calculated by neutralization titration of the copolymer hydrochloride was 49.71%, which was approximately equivalent to the result of the elemental analysis.

### Production Example 9

### Production of Modified PAA-9

### Terpolymer of DAMA, AA, and Carbamoylated AA (5/3/2)

As in Production Example 2a, 817.70 g (yield: 99%) of a 11.75% aqueous solution of free-type copolymer of N,N-diallylmethylamine, monocarbamoylethylated allylamine, and allylamine (copolymerization ratio of 5:3:2) was prepared by using 273.04 g of an aqueous solution of sodium cyanate and 58.80 g of an aqueous solution of sodium hydroxide. The weight-average molecular weight of this copolymer was 1800.

### Production Example 10

### Production of Modified PAA-10

### Terpolymer of DAMA, AA, and Methoxycarbonylated AA (5/3/2)

As in Production Example 3, 494.19 g (yield: 98%) of a 19.33% aqueous solution of free-type copolymer of N,N-diallylmethylamine, methoxycarbonylated allylamine, and allylamine (copolymerization ratio of 5:3:2) was prepared by using 28.66 g of dimethyl carbonate. The weight-average molecular weight of this copolymer was 1800.

### Production Example 11

### Production of Modified PAA-11

### Terpolymer of DAMA, AA, and Acetylated AA (5/3/2)

As in Production Example 4, 704.15 g (yield: 100%) of a 13.74% aqueous solution of free-type copolymer of N,N-diallylmethylamine, acetylated allylamine, and allylamine (copolymerization ratio of 5:3:2) was prepared by using 32.81 g of acetic anhydride and 25.20 g of an aqueous solution of sodium hydroxide. The weight-average molecular weight of this copolymer was 1800.

### Production Example 12

### Production of Modified PAA-12

### Terpolymer of DAMA, AA, and Monocarbamoylethylated AA (5/3/2)

As in Production Example 5, 611.07 g (yield: 98%) of a 17.26% aqueous solution of free-type copolymer of N,N-diallylmethylamine, methoxycarbonylated allylamine, and allylamine (copolymerization ratio of 5:3:2) was prepared by using 44.78 g of acrylamide. The weight-average molecular weight of this copolymer was 1800.

### Production Example 13

### Production of Modified PAA-13

### Terpolymer of DAMA, Monoethoxy-2-Hydroxypropylated AA, and AA (5/3/2)

As in Production Example 7, 586.51 g (yield: 100%) of a 19.57% aqueous solution of free-type copolymer of N,N-diallylmethylamine, monoethoxy-2-hydroxypropylated allylamine, and allylamine (copolymerization ratio of 5:3:2) was prepared by using 32.17 g of ethylglycidyl ether. The weight-average molecular weight of this copolymer was 1800.

### Production Example 14

### Production of Modified PAA-14

### Terpolymer of DAMA, DMAA, and Carbamoylated AA (1/1/1)

A 1000-mL four-neck separable flask equipped with a stirrer, a Dimroth reflux device, and a thermometer was charged with 212.20 g of a 69.58% aqueous solution of N,N-diallylmethylamine hydrochloride, 191.66 g of a 63.45% aqueous solution of N,N-dimethylallylamine hydrochloride, 159.10 g of 58.80% aqueous solution of monoallylamine hydrochloride, and 646.40 g of distilled water. The aqueous solution of the monomers was warmed to 65° C., and 54.24 g of 2,2′-azobis(2-amidinopropane)dihydrochloride was added thereto as a radical initiator, and polymerization was allowed to proceed for 48 hours.

After completion of the polymerization, 273.28 g of a 50% aqueous solution of sodium hydroxide was dropwise added thereto under ice-cooling to neutralize hydrochloric acid. After completion of the neutralization, unreacted monomers were evaporated at 50° C. under reduced pressure (10.6 kPa).

The thus-obtained solution was subjected to electrodialysis for desalting to obtain 1504.87 g of a 14.82% aqueous solution of free-type copolymer of N,N-diallylmethylamine, N,N-dimethylallylamine, and allylamine (polymerization ratio of 1:1:1).

Under ice-cooling, 104.17 g of 35% hydrochloric acid was dropwise added to 570.04 g of the obtained aqueous solution of the copolymer, followed by warming to 50° C. Then, 300.35 g of a 7.5% aqueous solution of sodium cyanate was dropwise added thereto, and a reaction was allowed to proceed for 24 hours.

The thus-obtained solution was subjected to electrodialysis for desalting to obtain 782.09 g (yield: 96%) of a 12.13% aqueous solution of free-type copolymer of N,N-diallylmethylamine, N,N-dimethylallylamine, and carbamoylated allylamine (polymerization ratio of 1:1:1). The weight-average molecular weight of this copolymer was 1700.

A copolymer hydrochloride was prepared by converting a part of the aqueous solution of the copolymer into a hydrochloride salt and reprecipitating the salt from an isopropanol solvent. The results of the elemental analysis were C=51.83, H=9.13, and N=14.97 and were in agreement with calculated values C=52.03, H=9.28, and N=15.17. The carbamoylation mole fraction calculated by neutralization titration of the copolymer hydrochloride was 31.84%, which was approximately equivalent to the result of the elemental analysis.

The components of each composition shown in the following Table 1 were mixed, and the resulting mixture was filtered through a membrane filter of 10 μm to prepare each ink. The numerical values shown in Table 1 represent contents (% by mass) in ink. The contents (% by mass) of the modified polyallylamine (in the Table, expressed as modified PAA) show the solid contents.

The surfactant used in Examples 1 to 30 was a polyorganosiloxane-based surfactant composed of a compound represented by the Formula (I) wherein R is a methyl group, a is an integer of 6 to 18, m is 0, and n is 1, a compound represented by the Formula (I) wherein R is a hydrogen atom, a is an integer of 7 to 11, m is an integer of 30 to 50, and n is an integer of 3 to 5, and a compound represented by the Formula (I) wherein R is a methyl group, a is an integer of 9 to 13, m is an integer of 2 to 4, and n is an integer of 1 or 2. When the surfactant was used as an aqueous solution containing 20% by mass of glycerin, 10% by mass of 1,2-hexanediol, 0.1% by mass of this surfactant, and 69.9% by mass of water, the dynamic surface tension of the aqueous solution was not higher than 26 mN/m at 1 Hz. Specifically, the dynamic surface tension of the aqueous solution measured at 1 Hz (one bubble/sec) with a bubble pressure dynamic surface tensiometer, BP2 (Kruss GmbH), was 24.6 mN/m.

The surfactant used in Comparative Examples 1 and 6 to 9 was the same polyorganosiloxane-based surfactant used in Examples.

When Surfynol 465 (an ethylene oxide adduct of 2,4,7,9-tetramethyl-5-decyne-4,7-diol) used in Comparative Example 2, which is an acetylene glycol-based surfactant manufactured by Nissin Chemical Industry Co Ltd., was used in an aqueous solution containing 20% by mass of glycerin, 10% by mass of 1,2-hexanediol, 0.1% by mass of this surfactant, and 69.9% by mass of water, the dynamic surface tension of the aqueous solution was not lower than 27 mN/m at 1 Hz. Specifically, the dynamic surface tension of the aqueous solution measured at 1 Hz (one bubble/sec) with a bubble pressure dynamic surface tensiometer, BP2 (Kruss GmbH), was 27.5 mN/m.

When Surfynol 104 (2,4,7,9-tetramethyl-5-decyne-4,7-diol) used in Comparative Example 3, which is an acetylene glycol-based surfactant manufactured by Nissin Chemical Industry Co., Ltd., was used in an aqueous solution containing 20% by mass of glycerin, 10% by mass of 1,2-hexanediol, 0.1% by mass of this surfactant, and 69.9% by mass of water, the dynamic surface tension of the aqueous solution was not lower than 27 mN/m at 1 Hz. Specifically, the dynamic surface tension of the aqueous solution measured at 1 Hz (one bubble/sec) with a bubble pressure dynamic surface tensiometer, BP2 (Kruss GmbH), was 27.8 mN/m.

In Comparative Example 4, BYK 347, which is a polyorganosiloxane-based surfactant manufactured by BYK-Chemie Japan, was used, and in Comparative Example 5, BYK 348, which is a polyorganosiloxane-based surfactant manufactured by BYK-Chemie Japan, was used.

Tripropylene glycol manufactured by Asahi Glass Co., Ltd. was used as the tripropylene glycol; Treha powder, a product of Hayashibara Shoji, Inc., was used as the trehalose; and AQUACER 593 is a product of BYK-Chemie Japan.

TABLE 1

| | Example 1 | Example 2 | Example 3 | Example 4 | Example 5 | Example 6 | Example 7 |
|---|---|---|---|---|---|---|---|
| 1,2-Octanediol | 3 | 3 | 3 | 3 | 3 | 3 | 3 |
| Tripropylene glycol | 6 | 6 | 6 | 12 | 12 | 12 | 18 |
| Trehalose | 12 | 24 | 36 | 12 | 24 | 36 | 12 |
| Glycerin | 5 | 5 | 5 | 5 | 5 | 5 | 5 |
| 1,2-Hexanediol | 1 | 1 | 1 | 1 | 1 | 1 | 1 |
| Surfactant | 0.3 | 0.3 | 0.3 | 0.3 | 0.3 | 0.3 | 0.3 |
| Modified PAA | Production | Production | Production | Production | Production | Production | Production |
| (as solid content) | Example 2a | Example 2a | Example 2a | Example 2a | Example 2a | Example 2a | Example 2a |
| | 2.4 | 2.4 | 2.4 | 2.4 | 2.4 | 2.4 | 2.4 |
| Ultrapure water | balance | balance | balance | balance | balance | balance | balance |
| Total | 100 | 100 | 100 | 100 | 100 | 100 | 100 |
| Evaluation of beading | AA | AA | AA | AA | AA | AA | AA |
| Evaluation of dot | AA | AA | AA | AA | AA | AA | AA |
| diameter | | | | | | | |
| Evaluation of curling | B | A | A | B | A | A | A |

| | Example 8 | Example 9 | Example 10 | Example 11 | Example 12 | Example 13 |
|---|---|---|---|---|---|---|
| 1,2-Octanediol | 3 | 3 | 3 | 3 | 3 | 3 |
| Tripropylene glycol | 18 | 18 | 6 | 6 | 6 | 12 |
| Trehalose | 24 | 36 | 12 | 24 | 36 | 12 |
| Glycerin | 5 | 5 | 5 | 5 | 5 | 5 |
| 1,2-Hexanediol | 1 | 1 | 1 | 1 | 1 | 1 |
| Surfactant | 0.3 | 0.3 | 0.3 | 0.3 | 0.3 | 0.3 |
| Modified PAA | Production | Production | Production | Production | Production | Production |
| (as solid content) | Example 2a | Example 2a | Example 2a | Example 2a | Example 2a | Example 2a |
| | 2.4 | 2.4 | 7.2 | 7.2 | 7.2 | 7.2 |
| Ultrapure water | balance | balance | balance | balance | balance | balance |
| Total | 100 | 100 | 100 | 100 | 100 | 100 |
| Evaluation of beading | AA | AA | AA | AA | AA | AA |
| Evaluation of dot | AA | AA | S | S | S | S |
| diameter | | | | | | |
| Evaluation of curling | A | A | B | A | A | B |
| | Example 14 | Example 15 | Example 16 | Example 17 | Example 18 | Example 19 |
| 1,2-Octanediol | 3 | 3 | 3 | 3 | 3 | 3 |
| Tripropylene glycol | 12 | 18 | 12 | 12 | 12 | 12 |
| Trehalose | 24 | 12 | 24 | 24 | 24 | 24 |
| Glycerin | 5 | 5 | 5 | 5 | 5 | 5 |
| 1,2-Hexanediol | 1 | 1 | 1 | 1 | 1 | 1 |
| Surfactant | 0.3 | 0.3 | 0.3 | 0.3 | 0.3 | 0.3 |
| Modified PAA | Production | Production | Production | Production | Production | Production |
| (as solid content) | Example 2a | Example 2a | Example 1 | Example 2b | Example 2c | Example 3 |
| | 7.2 | 7.2 | 7.2 | 7.2 | 7.2 | 7.2 |
| Ultrapure water | balance | balance | balance | balance | balance | balance |
| Total | 100 | 100 | 100 | 100 | 100 | 100 |
| Evaluation of beading | AA | AA | A | AA | AA | AA |
| Evaluation of dot | S | S | S | S | S | S |
| diameter | | | | | | |
| Evaluation of curling | A | A | A | A | A | A |
| | Example 20 | Example 21 | Example 22 | Example 23 | Example 24 | Example 25 |
| 1,2-Octanediol | 3 | 3 | 3 | 3 | 3 | 3 |
| Tripropylene glycol | 12 | 12 | 12 | 12 | 12 | 12 |
| Trehalose | 24 | 24 | 24 | 24 | 24 | 24 |
| Glycerin | 5 | 5 | 5 | 5 | 5 | 5 |
| 1,2-Hexanediol | 1 | 1 | 1 | 1 | 1 | 1 |
| Surfactant | 0.3 | 0.3 | 0.3 | 0.3 | 0.3 | 0.3 |
| Modified PAA | Production | Production | Production | Production | Production | Production |
| (as solid content) | Example 4 | Example 5 | Example 6 | Example 7 | Example 8 | Example 9 |
| | 7.2 | 7.2 | 7.2 | 7.2 | 7.2 | 7.2 |
| Ultrapure water | balance | balance | balance | balance | balance | balance |
| Total | 100 | 100 | 100 | 100 | 100 | 100 |
| Evaluation of beading | AA | AA | AA | AA | AA | AA |
| Evaluation of dot | S | S | S | S | S | S |
| diameter | | | | | | |
| Evaluation of curling | A | A | A | A | A | A |

| | Example 26 | Example 27 | Example 28 | Example 29 | Example 30 |
|---|---|---|---|---|---|
| 1,2-Octanediol | 3 | 3 | 3 | 3 | 3 |
| Tripropylene glycol | 12 | 12 | 12 | 12 | 12 |
| Trehalose | 24 | 24 | 24 | 24 | 24 |
| Glycerin | 5 | 5 | 5 | 5 | 5 |
| 1,2-Hexanediol | 1 | 1 | 1 | 1 | 1 |
| Surfactant | 0.3 | 0.3 | 0.3 | 0.3 | 0.3 |
| Modified PAA | Production | Production | Production | Production | Production |
| (as solid content) | Example 10 | Example 11 | Example 12 | Example 13 | Example 14 |
| | 7.2 | 7.2 | 7.2 | 7.2 | 7.2 |
| Ultrapure water | balance | balance | balance | balance | balance |
| Total | 100 | 100 | 100 | 100 | 100 |
| Evaluation of beading | AA | AA | AA | AA | AA |
| Evaluation of dot | S | S | S | S | S |
| diameter | | | | | |
| Evaluation of curling | A | A | A | A | A |

* The modified PAA used in each Example is the modified PAA produced as described in the corresponding production
example.

| | Comparative | Comparative | Comparative | Comparative | Comparative |
|---|---|---|---|---|---|
| | Example 1 | Example 2 | Example 3 | Example 4 | Example 5 |
| 1,2-Octanediol | 0 | 0 | 0 | 0 | 0 |
| Tripropylene glycol | 12 | 12 | 12 | 12 | 12 |
| Trehalose | 24 | 24 | 24 | 24 | 24 |
| Glycerin | 5 | 5 | 5 | 5 | 5 |
| 1,2-Hexanediol | 1 | 1 | 1 | 1 | 1 |
| Surfactant | 0.3 | — | — | — | — |
| (polyorganosiloxane- | | | | | |
| based) | | | | | |
| Surfactant (Surfynol | — | 0.3 | — | — | — |
| 465) | | | | | |
| Surfactant (Surfynol | — | — | 0.3 | — | — |
| 104) | | | | | |
| Surfactant (BYK 347) | — | — | — | 0.3 | — |
| Surfactant (BYK 348) | — | — | — | — | 0.3 |
| Modified PAA | Production | Production | Production | Production | Production |
| (as solid content) | Example 2a | Example 2a | Example 2a | Example 2a | Example 2a |
| | 2.4 | 2.4 | 2.4 | 2.4 | 2.4 |
| AQUACER 593 | 0 | 0 | 0 | 0 | 0 |
| (40% Solid content) | | | | | |
| Ultrapure water | balance | balance | balance | balance | balance |
| Total | 100 | 100 | 100 | 100 | 100 |
| Evaluation of beading | C | C | C | C | C |
| Evaluation of dot | B | B | B | B | B |
| diameter | | | | | |
| Evaluation of curling | A | A | A | A | A |

| | Comparative | Comparative | Comparative | Comparative |
|---|---|---|---|---|
| | Example 6 | Example 7 | Example 8 | Example 9 |
| 1,2-Octanediol | 3 | 0 | 3 | 3 |
| Tripropylene glycol | 12 | 12 | 12 | 0 |
| Trehalose | 24 | 24 | 0 | 24 |
| Glycerin | 5 | 5 | 5 | 5 |
| 1,2-Hexanediol | 1 | 1 | 1 | 1 |
| Surfactant | 0.3 | 0.3 | 0.3 | 0.3 |
| (polyorganosiloxane- | | | | |
| based) | | | | |
| Surfactant (Surfynol | — | — | — | — |
| 465) | | | | |
| Surfactant (Surfynol | — | — | — | — |
| 104) | | | | |
| Surfactant (BYK 347) | — | — | — | — |
| Surfactant (BYK 348) | — | — | — | — |
| Modified PAA | — | — | Production | Production |
| (as solid content) | | | Example 2a | Example 2a |
| | 0 | 0 | 2.4 | 2.4 |
| AQUACER 593 | 6 | 6 | 0 | 0 |
| (40% Solid content) | | | | |
| Ultrapure water | balance | balance | balance | balance |
| Total | 100 | 100 | 100 | 100 |
| Evaluation of beading | B | C | B | A |
| Evaluation of dot | C | C | B | A |
| diameter | | | | |
| Evaluation of curling | A | A | B | B |

* The modified PAA used in each Comparative Example is the modified PAA
produced as described in the corresponding production example.

### Preparation of Ink Composition Containing a Colorant

### Reference Examples 1 to 4

The components of each composition shown in the following Table 2 were mixed, and the mixture was filtered through a membrane filter of 10 μm to prepare each ink. The numerical values shown in Table 2 represent contents (% by mass) in ink. The oxyethyl acrylate-based resin (oxyethyl resin) in Table 2 is a resin with a molecular weight of 6900 containing a monomer having an oxyethyl acrylate structure shown by CAS No. 72009-86-0 in a monomer component proportion of about 75% by mass.

The fluorene-based resin (fluorene resin) is a resin with a molecular weight of 3300 containing a monomer having a fluorene structure shown by CAS No. 117344-32-8 in a monomer component proportion of about 50% by mass.

The surfactant used in Reference Examples 1 to 4 was a polyorganosiloxane-based surfactant composed of a compound represented by Formula (I) wherein R is a methyl group, a is an integer of 6 to 18, m is 0, and n is 1, a compound represented by Formula (I) wherein R is a hydrogen atom, a is an integer of 7 to 11, m is an integer of 30 to 50, and n is an integer of 3 to 5, and a compound represented by Formula (I) wherein R is a methyl group, a is an integer of 9 to 13, m is an integer of 2 to 4, and n is an integer of 1 or 2. When the surfactant was used in an aqueous solution containing 20% by mass of glycerin, 10% by mass of 1,2-hexanediol, 0.1% by mass of the surfactant, and 69.9% by mass of water, the dynamic surface tension of the aqueous solution was not higher than 26 mN/m at 1 Hz. Specifically, the dynamic surface tension of the aqueous solution measured at 1 Hz (one bubble/sec) with a bubble pressure dynamic surface tensiometer, BP2 (Kruss GmbH), was 24.6 mN/m. Tripropylene glycol manufactured by Asahi Glass Co., Ltd. was used as the tripropylene glycol; and Treha powder, a product of Hayashibara Shoji, Inc., was used as the trehalose.

TABLE 2

| | | Reference | Reference | Reference | Reference |
|---|---|---|---|---|---|
| | | Example 1 | Example 2 | Example 3 | Example 4 |
| | | Lc | Y | K | Lm |
| 1,2-Octanediol | | 2 | 2 | 2 | 2 |
| Tripropylene glycol | | 6 | 6 | 6 | 6 |
| Trehalose | | 12 | 12 | 12 | 12 |
| Glycerin | | 5 | 5 | 5 | 5 |
| 1,2-Hexanediol | | 1 | 1 | 1 | 1 |
| Surfactant | | 0.3 | 0.3 | 0.3 | 0.3 |
| Dispersion | Oxyethyl | 0.4 | 1.4 | 2.8 | 0.4 |
| | resin | | | | |
| | Fluorene | 0.4 | 1.4 | 2.8 | 0.4 |
| | resin | | | | |
| | Pigment | 2 | 7 | 7 | 2 |

| | | | | |
|---|---|---|---|---|
| Ultrapure water | 70.9 | 63.9 | 61.1 | 70.9 |
| Total | 100 | 100 | 100 | 100 |
| Evaluation of beading | A | AA | AA | A |
| Evaluation of dot | B | A | A | B |
| diameter | | | | |
| Evaluation of curling | B | B | B | B |

* In the following ink sets, “Y” represents an ink composition containing C.I. Pigment Yellow 74 as the pigment, “Lm” represents an ink composition containing C.I. Pigment Violet 19 as the pigment, “Lc” represents an ink composition containing C.I. Pigment Blue 15:3 as the pigment, and “K” represents an ink composition containing C.I. Pigment Black 7 as the pigment.

### Evaluation

### Evaluation of Ink Beading (Image Quality)

Ink compositions Y, K, Lc, and clear ink (hereinafter may be simply referred to as “Im”) prepared above were mounted on an ink cartridge of an ink jet printer (PX-20000, manufactured by Seiko Epson Corp.) so as to correspond to the nozzle lines in the order Y/Y/K/K/Lc/Lc/Im/Im from the cap side and to perform recording at 360 dpi in the main scanning (head driving) direction and at 720 dpi in the sub-scanning (recording medium transporting) direction. Then, the voltage applied to a piezo element of the printer head was adjusted such that the dot weight at the time of landing was about 3 ng, and an image of 720×1440 dpi was recorded at 360×720 dpi per one driving on OKT+ (manufactured by Oji Paper Co., Ltd.) having a paper weight of about 128 g/m². The recording was conducted under an environment of ordinary temperature and ordinary humidity (25° C., 45% RH). On this occasion, the amount of adhering ink of a monochromatic color at 100% duty was about 3.1 mg/inch².

In this specification, the term “duty” is a value calculated by the following expression:

Duty(%)=(number of actually recorded dots)/[(vertical resolution)×(horizontal resolution)]×100

(in the expression, the term “number of actually recorded dots” refers to the number of dots actually recorded per unit area; and the terms “vertical resolution” and “horizontal resolution” each refer to the resolution per unit area).

The distance between the recording sheet and the recording head was 1 mm.

As a recorded image, an image of a secondary color obtained by mixing monochromatic colors of the same duty formed after discharging the Im ink (average dot diameter: 50 μm) at 20% duty was evaluated. Accordingly, for example, the term “100% duty as a secondary color” means that recording was performed with different two monochromatic color inks each at 50% duty. The calculated coverage proportion of the clear ink in the evaluation above was 63%.

In the printer PX-20000, wipers are divided for each two nozzle lines in sequence from the cap side, and, thereby, the wiper for the clear ink does not wipe the nozzle lines of colored inks.

The resulting images were evaluated in accordance with the following criteria:

AA: a secondary color is reproduced without beading up to 180% duty when the secondary color image is recorded after recording with a clear ink at 20% duty;

A: a secondary color is reproduced without beading up to 160% duty when the secondary color image is recorded after recording with a clear ink at 20% duty;

B: a secondary color is reproduced without beading up to 140% duty when the secondary color image is recorded after recording with a clear ink at 20% duty; and

C: a secondary color is reproduced without beading up to 120% duty when the secondary color image is recorded after recording with a clear ink at 20% duty.

The results are shown in Tables 1 and 2.

### Evaluation of Dot Diameter

Ink compositions Y, K, Lc, and clear ink (hereinafter may be simply referred to as “Im”) prepared above were mounted on an ink cartridge of an ink jet printer (PX-G930, manufactured by Seiko Epson Corp.) so as to correspond to the nozzle lines in the order Y/Y/K/K/Lc/Lc/Im/Im from the cap side and to perform recording at 720 dpi in the main scanning (head driving) direction and at 360 dpi in the sub-scanning (recording medium transporting) direction. Then, the voltage applied to a piezo element of the printer head was adjusted such that the dot weight at the time of landing was about 3 ng, and an image of 720×720 dpi was recorded at 720×360 dpi per one driving on OKT+ (manufactured by Oji Paper Co., Ltd.) having a paper weight of about 128 g/m². The images were formed with the clear ink at 20% duty and the ink of Reference Example 1 or 2 at 5% duty. The recording was conducted under an environment of ordinary temperature and ordinary humidity (25° C., 45% humidity). On this occasion, the amount of adhering ink of a monochromatic color at 100% duty was about 3.1 mg/inch².

The distance between the recording sheet and the recording head was 1 mm. The recorded images are monochromatic images. The results described in Reference Examples 1 to 3 of Table 2 are the results of evaluation when the clear ink was not used.

The resulting images were evaluated in accordance with the following criteria:

S: dot diameter is smaller than 40 μm;

AA: dot diameter is not smaller than 40 μm and smaller than 50 μm;

A: dot diameter is not smaller than 50 μm and smaller than 60 μm;

B: dot diameter is not smaller than 60 μm and smaller than 70 μm; and

C: dot diameter is not smaller than 70 μm.

The results are shown in Tables 1 and 2.

### Evaluation of Curling

Ink compositions Y, K, Lc, and clear ink (hereinafter may be simply referred to as “Im”) prepared above were mounted on an ink cartridge of an ink jet printer (PX-20000, manufactured by Seiko Epson Corp.) so as to correspond to the nozzle lines in the order Y/Y/K/K/Lc/Lc/Im/Im from the cap side and to perform recording at 360 dpi in the main scanning (head driving) direction and at 720 dpi in the sub-scanning (recording medium transporting) direction. Then, the voltage applied to a piezo element of the printer head was adjusted such that the dot weight at the time of landing was about 3 ng, and a solid image of 720×720 dpi was recorded at 360×720 dpi per one driving on OKT+ (manufactured by Oji Paper Co., Ltd.) having a paper weight of about 73.3 g/m² and on Xerox P (manufactured by Fuji Xerox Co., Ltd.) having a paper weight of about 60 g/m², with a margin of about 6 mm on the periphery. The recording was conducted under an environment of ordinary temperature and ordinary humidity (25° C., 45% humidity). On this occasion, the amount of adhering ink of a monochromatic color at 100% duty was about 1.6 mg/inch². The resulting recorded matters were placed on a flat table with the recorded surfaces upward and were left to stand for three days under an environment of ordinary temperature and ordinary humidity (25° C., 45% humidity).

The recorded images were images of the clear ink of 0.6 mg/inch² and a colored monochromatic ink of 1.6 mg/inch².

The resulting images were evaluated in accordance with the following criteria. For each of the two types of the recording paper, the distances from the table to the four rolled corners of each recording paper were measured, and the average thereof was calculated to obtain the average (OKT+) in the OKT+ and the average (XeroxP) in the Xerox P. The average (ALL) of the two types of recording paper was further calculated and was used as an index of the evaluation.

A: the average (ALL) is smaller than 10 mm;

B: the average (ALL) is not smaller than 10 mm and smaller than 20 mm; and

C: the average (ALL) is not smaller than 20 mm.

The results are shown in Tables 1 and 2.

In the above-described evaluations of ink beading, dot edge, and curling, the same evaluation results were obtained when Lm (Reference Example 4) was used instead of the Lc (Reference Example 1).

What is claimed is:

1. A clear ink composition, comprising:
an amino group-containing resin;
water;
a poor water-soluble alkanediol having 7 or more carbon atoms;
a crystalline carbohydrate being solid at 20° C.; and
a poly(oxyalkylene glycol),
wherein the composition is essentially free of colorant.

2. The ink composition according to claim 1, having an impregnation function.

3. The ink composition according to claim 1, wherein
the crystalline carbohydrate is one or more selected from the group consisting of trehalose, isotrehalose, neotrehalose, and sucrose.

4. The ink composition according to claim 1, further comprising:
a water-soluble alkanediol,
wherein the sum of the contents of the crystalline carbohydrate, the water-soluble alkanediol, and the poor water-soluble alkanediol is 16.0% by mass or more and 40.0% by mass or less based on the total mass of the ink composition.

5. The ink composition according to claim 1, wherein
the amino group-containing resin is a modified polyallylamine including repeating units (a) and (d) represented by the following formulae as essential structural monomers and a repeating unit (b) and/or a repeating unit (c) represented by the following formulae as an optional structural monomer or monomers: 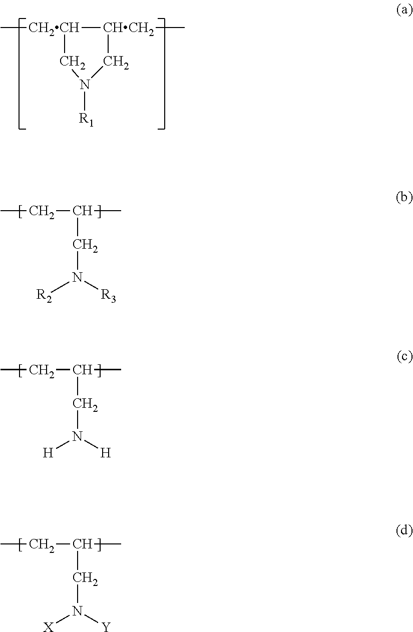
(in the formulae,
R₁, R₂, and R₃ each independently represent an alkyl group having 1 to 4 carbon atoms;
X is any one of the following (i) to (v):
(i) —CONH₂;
(ii) —COOR₄ (wherein R₄ represents an alkyl group having 1 to 12 carbon atoms or an aryl group having 6 to 12 carbon atoms);
(iii) —COR₅ (wherein R₅ represents an alkyl group having 1 to 12 carbon atoms);
(iv) —CH₂CH(R₆)-A (wherein R₆ represents a hydrogen atom or a methyl group, and A is selected from the group consisting of —CONR₇R₈ (R₇ and R₈ each independently represent a hydrogen atom or an alkyl group having 1 to 8 carbon atoms (the alkyl group may be substituted by a group selected from the group consisting of hydroxy groups, keto groups, monoalkylamino groups having 1 to 4 carbon atoms, di(alkyl having 1 to 4 carbon atoms)amino groups, and tri(alkyl having 1 to 4 carbon atoms)ammonium groups), or NR₇R₈ represents a cyclic amino group of a piperidino group or a morpholino group as a whole), —CN, and COOR₉ (wherein R₉ represents an alkyl group having 1 to 8 carbon atoms (the alkyl group may be substituted by a group selected from the group consisting of hydroxy groups, keto groups, monoalkylamino groups having 1 to 4 carbon atoms, di(alkyl having 1 to 4 carbon atoms)amino groups, and tri(alkyl having 1 to 4 carbon atoms)ammonium groups)); and
(v) —CH₂CH(OH)—B (wherein B represents an alkyl group having 1 to 8 carbon atoms (the alkyl group may be substituted by a group selected from the group consisting of hydroxy groups, alkoxy groups having 1 to 4 carbon atoms, and alkenyloxy groups);
Y represents the same meaning as the above-referenced X or represents a hydrogen atom; and
X and Y may be the same or different for each repeating unit).

6. The ink composition according to claim 5, wherein
the modified polyallylamine includes the repeating unit (b) in a proportion of 0 to 90% of the total number of the repeating units (a) and (b).

7. The ink composition according to claim 5, wherein
the modified polyallylamine includes the repeating units (a) and (b) in a proportion of 5 to 95% of the total number of the repeating units (a), (b), (c), and (d).

8. The ink composition according to claim 5, wherein
the modified polyallylamine includes the repeating unit (d) in a proportion of 60 to 100% of the total number of the repeating units (c) and (d).

9. The ink composition according to claim 5, wherein
the modified polyallylamine has a weight-average molecular weight of 200 or more and 12000 or less.

10. The ink composition according to claim 1, wherein the poly(oxyalkylene glycol) is one or more selected from the group consisting of triethylene glycol, propylene glycol, dipropylene glycol, and tripropylene glycol.

11. The ink composition according to claim 1, wherein, based on the total mass of the ink composition,
the content of the poly(oxyalkylene glycol) is 6% by mass or more and 18% by mass or less;
the content of the crystalline carbohydrate is 12% by mass or more and 36% by mass or less; and
the content of the water is 30% by mass or more and 74% by mass or less, and
the ratio of the sum of the contents of the poly(oxyalkylene glycol) and the crystalline carbohydrate to the content of the water is 5:3 to 1:4.

12. The ink composition according to claim 4, wherein, based on the total mass of the ink composition,
the content of the poor water-soluble alkanediol is 1.0% by mass or more and 5.0% by mass or less; and
the content of the water-soluble alkanediol is 0.1% by mass or more and 4.0% by mass or less, and
the ratio of the content of the poor water-soluble alkanediol to the content of the water-soluble alkanediol is 1:1 to 10:1.

13. The ink composition according to claim 1, further comprising:
a surfactant,
wherein the surfactant is a polyorganosiloxane-based surfactant and/or a Gemini-type surfactant, wherein
the polyorganosiloxane-based surfactant contains one or more compounds represented by the following formula: 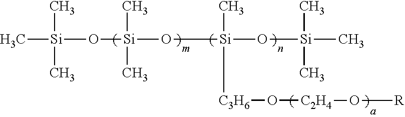
(in the formula, R represents a hydrogen atom or a methyl group; a represents an integer of 2 to 13; m represents an integer of 2 to 70; and n represents an integer of 1 to 8).

14. The ink composition according to claim 1, further comprising:
a surfactant,
wherein the surfactant is a polyorganosiloxane-based surfactant and/or a Gemini-type surfactant, wherein
the polyorganosiloxane-based surfactant contains one or more compounds represented by the following formula: 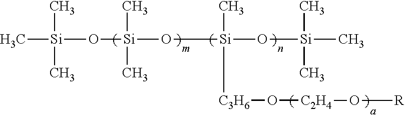
(in the formula, R represents a methyl group; a represents an integer of 6 to 18; m represents an integer of 0 to 4; and n represents 1 or 2).
